(19) United States
(12) Patent Application Publication
(10) Pub. No.: US 2007/0083629 A1
(43) Pub. Date: Apr. 12, 2007

(54) DATA PROCESSING SYSTEM, DATA MANAGING APPARATUS, AND COMPUTER PRODUCT

(76) Inventor: Satoru Sugishita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/469,044

(22) Filed: Aug. 31, 2006

(30) Foreign Application Priority Data
Sep. 16, 2005 (JP) 2005-271045

(51) Int. Cl. G06F 15/173

(52) U.S. Cl. 709/223

(57) ABSTRACT

A first communication processing unit and a second communication processing unit communicates with a data processing device and a data storing device, respectively. An information managing unit stores and manages identification information for identifying the data storing device and the data processing device that is permitted to use the data stored in the data storing device. A control unit converts a format of data from the data storing device into a format that can be used by the data processing device, and converts a format of data from the data processing device into a format that can be used by the data storing device.

### CROSS-REFERENCE TO RELATED APPLICATIONS

The present document incorporates by reference the entire contents of Japanese priority document, 2005-271045 filed in Japan on Sep. 16, 2005.

### BACKGROUND OF THE INVENTION

1. Field of the Invention

The present invention relates to a data processing system including data processing devices, such as a terminal unit (e.g., a personal computer (PC)) that processes data, an image forming apparatus (e.g., a digital copying machine, a printer, a facsimile machine, or a digital multifunction product (MFP)), and an image reading apparatus (e.g., a scanner), each connected to a communication circuit (a network), a data storage unit that stores data, a data managing apparatus that manages the data. The present invention also relates to a data managing apparatus therefor, a program that is executed by a computer (a central processing unit (CPU)) to function as the data managing apparatus, and a computer readable recording medium having the program recorded therein.

2. Description of the Related Art

Conventionally, terminal units like PCs (Personal Computers) are connected one to one to an image forming apparatus such as a digital MFP, by cables. Each terminal unit generates (creates) print data, such as a document data according to an operation of a keyboard or the like on a screen of a monitor (a display unit) by, for example, an application (application software), and when a print request is issued by an operation of the keyboard or the like, a printer driver (a printer driver program) interprets (converts) the print data in a language which the image forming apparatus can recognize, and a print order (a print instruction) including the interpreted print data and a print condition is sent to the image forming apparatus to make a print.

Applications, which provide a user interface and realize functions to be presented to a user, include an application to realize a copy function (a copy application), an application to realize a printer function (a printer application), an application to realize a scanner function (a scanner application), and an application to realize a facsimile (FAX) function (a FAX application). These applications are managed by an operating system (OS).

Demands for the technology of a communication circuit such as a network are increasing the amount and types of data to be handled. This trend results in increasing demands for better usability and economical improvement. In this respect, recently, there are image forming systems (a data processing system) that include a plurality of image forming apparatuses with different functions separately located and connected to a network, and allow the image forming apparatuses to be available selectively.

One of such image forming systems includes a print managing server also connected to a network to collectively manage a plurality of image forming apparatuses in addition to terminal units, so that the print managing server selectively sends print data from the terminal units to the image forming apparatuses to be printed (Japanese Patent Application Laid-open No. 2004-213370).

Some of such image forming systems further include devices (data storage units) or servers including a plurality of databases (DBs) of different types, such as a user managing server for notes, a user registering Windows NT™ server, and a user managing server for a Unix™ PC, on a network, and includes a module (software) for a process of connecting to DB devices each including an available DB as image forming apparatuses (data processing devices) on a network (a process of connecting to DB devices in a communicable manner).

However, such a conventional image forming system needs to change software for a process of connecting to a DB device for each image forming apparatus when performing a process of connecting to a DB (a new type of DB) device extended on a network, or when performing a process of connecting to a changed DB device on a network. This leads to a significant increase in cost for changing the software.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram of an example of a network connection of a data processing system according to a first embodiment of the present invention;

FIG. 2 is a block diagram of a hardware configuration example of an MFP in FIG. 1;

FIG. 3 is a block diagram of a hardware configuration example of a normal PC in FIG. 1;

FIG. 4 is a block diagram of a hardware configuration example of a data storing PC in FIG. 1;

FIG. 5 is a block diagram of a hardware configuration example of a data managing PC in FIG. 1;

FIG. 6 is a block diagram of a configuration example of relevant functions of the data managing PC in FIG. 1;

FIG. 7 is an example of a communication sequence when the data storing PC in the data processing system in FIG. 1 is activated;

FIG. 8 is an example of a communication sequence when the data managing PC is activated;

FIG. 9 is an example of a communication sequence when a data acquisition request is generated by the MFP;

FIG. 10 is an example of a communication sequence when a data change request is generated by the MFP;

FIG. 11 is an example of a communication sequence when a data change occurrence notification is sent from the data storing PC;

FIG. 12 is an example of a communication sequence when a data change request is generated by the MFP and a data change is permitted;

FIG. 13 is an example of a communication sequence when a data change request is generated by the MFP and a data change is not permitted;

FIG. 14 is an example of a communication sequence when a data change occurrence notification is sent from the data storing PC and a data change is permitted;

FIG. 15 is an example of a communication sequence when a data change occurrence notification is sent from the data storing PC and a data change is not permitted;

FIG. 16 is a block diagram for explaining a change of the data storing PC in FIG. 6 along with a change of a PC2 specific processor;

FIG. 17 is a conceptual diagram of an example of a network connection of a data processing system according to a second embodiment of the present invention;

FIG. 18 is a block diagram of a configuration example of relevant functions of the data managing PC in FIG. 17;

FIG. 19 is a block diagram of a configuration example of relevant functions of a data managing PC, which configures a data processing system according to a first reference example of the present invention;

FIG. 20 is a block diagram of a configuration example of relevant functions of a data managing PC, which configures a data processing system according to a second reference example of the present invention; and

FIG. 21 is a block diagram of a configuration example of relevant functions of a data managing PC, which configures a data processing system according to a third reference example of the present invention.

### DETAILED DESCRIPTION OF THE PREFERRED EMBODIMENTS

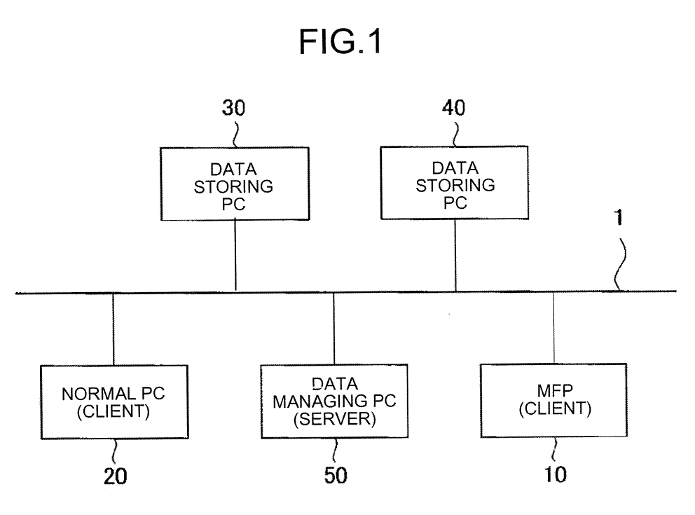

Exemplary embodiments of the present invention will be explained below in detail with reference to the accompanying drawings. An outline of a data processing system according to one embodiment of the present invention is explained below with reference to FIG. 1.

FIG. 1 is a conceptual diagram of an example of a network connection of the data processing system according to a first embodiment of the present invention. The data processing system includes a digital multifunction product (MFP) 10 and a normal PC 20 as data processing devices (clients), data storing PCs 30, 40 as data storage units, and a data managing PC (a server) 50 as a data managing apparatus. The MFP 10, the normal PC 20, the data storing PCs 30, 40, and the data managing PC 50 can be connected to one another in a communicable manner over a network (a communication circuit) 1, such as a local area network (LAN). The network 1 can be separated into two networks, so that the MFP 10 and the normal PC 20 as data processing devices can be connected to one network, the data storing PCs 30, 40 as data storage units can be connected to the other network, and the data managing PC 50 as a data managing apparatus can be connected to both networks. This configuration allows the MFP 10 and the normal PC 20 to communicate with the data storing PCs 30, 40 only via the data managing PC 50.

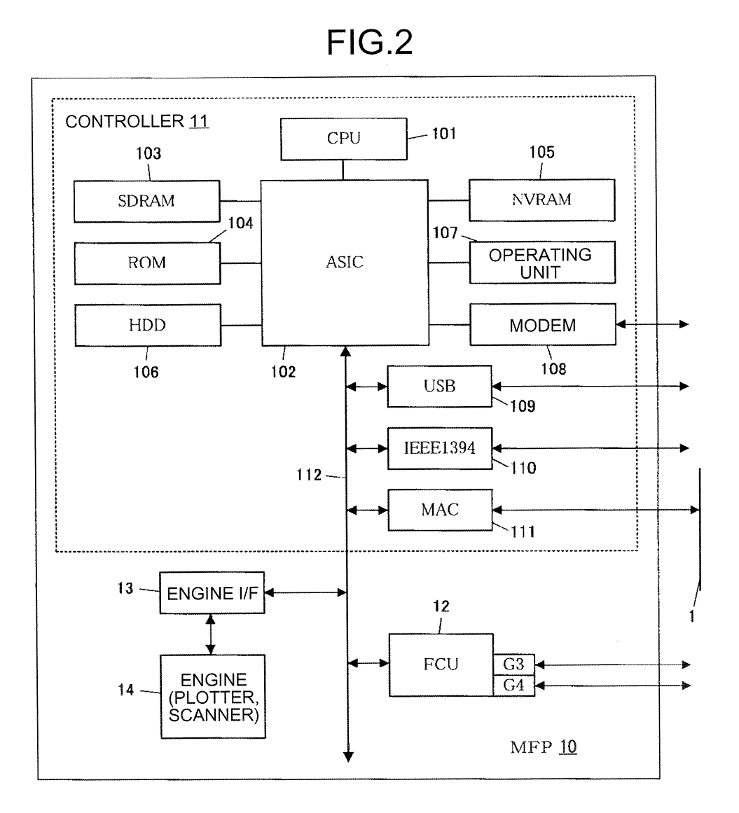

A hardware configuration example of the MFP 10 in FIG. 1 is specifically explained below with reference to FIG. 2. FIG. 2 is a block diagram of the hardware configuration example of the MFP 10 in FIG. 1. The MFP 10 is an image forming apparatus capable of achieving various functions including functions as a digital copying machine, a printer, a FAX machine, a scanner device, namely, a copy function, a printer function (a printing function), a FAX function, and a scanner function. As shown in FIG. 2, the MFP 10 includes a controller 11, a fax control unit (FCU) 12, an engine interface (I/F) 13, and an engine 14. Those components are hardware resources for performing image processing, such as document image reading, printing (image formation) and image data transmission.

The controller 11 generally controls the individual components of the MFP 10. The control can achieve various functions.

The FCU 12 controls communications with an external device, such as a FAX machine or a digital copying machine including a modem function (a FAX communication function), and an image forming apparatus such as another MFP, via a public circuit.

The engine I/F 13 is an interface to connect the engine 14 to a peripheral component interconnect (PCI) bus. The engine 14 corresponds to hardware devices, such as a scanner (an image reading unit) that scans the image of a document, a plotter (an image forming unit) that prints image data scanned by the scanner or print data received from an external device as a visible image on a sheet of paper (other recording media can be also used), an automatic document feeder (ADF) that automatically feeds a document to the image reading position of the scanner, and a post-processing device that performs post processes, such as sorting, punching, or stapling, on the sheet of paper printed by the plotter.

The controller 11 includes a CPU 101, an application specific integrated circuit (ASIC) 102, a synchronous dynamic random access memory (SDRAM) 103, a read only memory (ROM) 104, a nonvolatile RAM (NVRAM) 105, a hard disk drive (HDD) 106, an operating unit 107, a modem 108, a universal serial bus (USB) I/F 109, an IEEE (Institute of Electrical and Electronic Engineers) 1394 I/F 110, and a media access controller (MAC) I/F 111. The operating unit 107 is actually located outside the controller 11.

The CPU 101 is an operating unit that performs data processing (control of various functions) via the ASIC 102.

The ASIC 102 is a multifunction device board including a CPU interface, an SDRAM interface, a local bus interface, a PCI interface, and an HDD interface, and permits sharing of devices to be controlled by the CPU 101 to assist highly efficient development of applications or the like from a viewpoint of architecture.

The ASIC 102 is connected directly with the operating unit 107 that accepts operational commands or the like from the engine 14, and is also connected directly with the modem 108. The USB I/F 109, the IEEE 1394 I/F 110, the MAC I/F 111, the FCU 12, and the engine I/F 13 are connected via a PCI bus 112 to the ASIC 102.

The SDRAM 103 is a main memory that is used as a program memory for storing various programs, and a work memory that the CPU 101 uses in performing data processing. The SDRAM 103 can be replaced with a dynamic RAM (DRAM) or a static RAM (SRAM).

The ROM 104 is a fixed memory storing programs to be executed by the CPU 101, and fixed data. Various applications can be stored in the ROM 104.

The NVRAM 105 is a non-volatile memory that stores data like various changeable parameters, and holds stored contents when its power is off. A non-volatile RAM having a RAM and a battery backup circuit integrated together, and a non-volatile memory, such as an electrically erasable programmable ROM (EEPROM) or a flash memory, can be used as the NVRAM 105.

The HDD 106 is a storage device (a recording medium) that stores and holds data regardless of whether its power is turned on or off. The HDD 106 can store data in the SDRAM 103 or data in the NVRAM 105.

The operating unit 107 includes various operation keys (also referred to as “operation switches” or “operation buttons”) for inputting data of an action instruction or the like to the engine 14, the normal PC 20 or the data managing PC 50, and a character display, such as a liquid crystal display (LCD) or a cathode ray tube (CRT).

The modem 108 is a modulating/demodulating unit that modulates data in a form compatible with a public circuit when sending the data to an external device (not shown) via the public circuit. When receiving modulated data sent from an external device, the modem 108 demodulates the data.

The USB I/F 109 and the IEEE 1394 I/F 110 are respectively interfaces (direct interfaces) of the USB standard and the IEEE 1394 standard for direct connection to and communication with an external device (a peripheral device).

The MAC I/F 111 is a network interface for communication with external devices including the normal PC 20, the data storing PCs 30, 40, and the data managing PC 50 over the network 1 like a LAN.

The controller 11 can be extended with a direct interface other than the USB I/F 109 and the IEEE 1394 I/F 110.

The “copy function” performs a copy operation of permitting the scanner to scan the image of a document, and sending the image data to the plotter to print (to form) the image data on a recording medium like a sheet of paper as a visible image.

The “printer function” performs a printer operation of sending data from an external device directly or after being processed to the plotter to print the data on a recording medium as a visible image.

The “scanner function” performs a scanner operation of permitting the scanner to scan the image of a document, and writing (storing) the image data in a memory (the SDRAM 103, the NVRAM 105, or the HDD 106).

It is possible to call up (read out) image data from the SDRAM 103 or the HDD 106 and print the image of a transfer sheet based on the image data by pressing a start key after executing the scanner operation.

The “FAX function” performs a FAX transmission operation of permitting the scanner to scan the image of a document, and permitting the FCU 12 to send the image data to an external device, and performs a FAX reception operation of permitting the FCU 12 to receive image data from an external device, send the image data to the plotter to form an image on a recording medium.

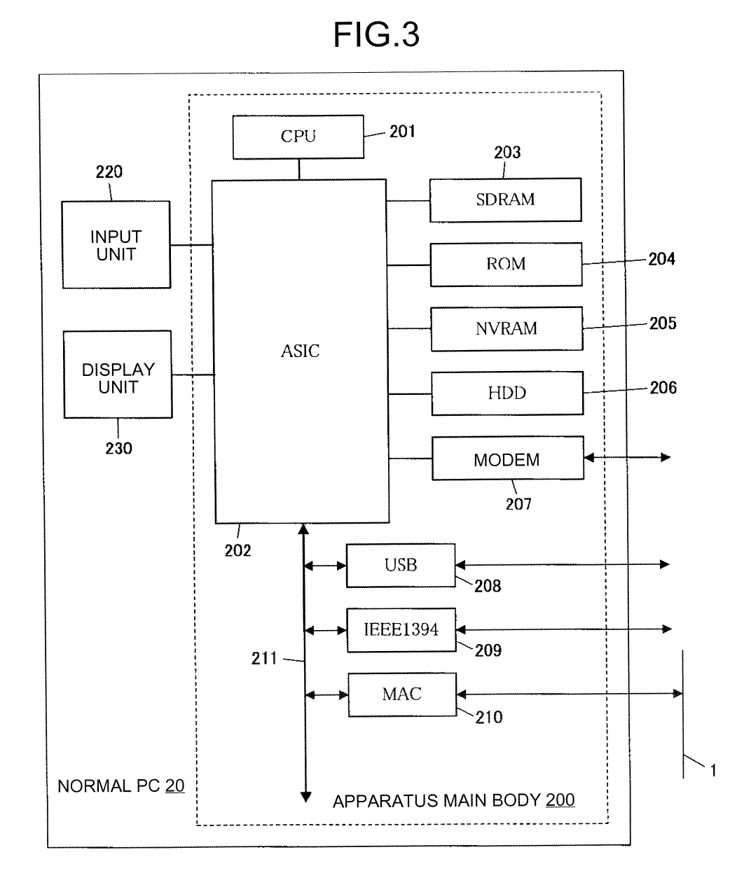

A hardware configuration example of the normal PC 20 in FIG. 1 is specifically explained below with reference to FIG. 3.

FIG. 3 is a block diagram of the hardware configuration example of the normal PC 20 in FIG. 1. The normal PC 20 is a terminal unit including a function of generating print data, such as document data and graphic data, and includes a apparatus main body 200, an input unit 220, and a display unit 230, as shown in FIG. 3.

The apparatus main body 200, which performs general control of the normal PC 20, includes a CPU 201, an ASIC 202, an SDRAM 203, a ROM 204, an NVRAM 205, an HDD 206, a modem 207, a USB I/F 208, an IEEE 1394 I/F 209, and a MAC I/F 210.

The hardware configuration of the apparatus main body 200 is substantially identical to the hardware configuration of the controller 11 of the MFP 10 explained with reference to FIG. 2.

The HDD 206 includes a browser and a printer driver (printer driver program) stored therein in addition to an OS and an application. The browser serves to display various kinds of data, such as print document data, on the screen of the display unit 230. The printer driver serves to give a print request and print data (including processed image data) to the MFP 10.

The input unit 220 corresponds to a keyboard for inputting data on an action command or the like and a pointing device, such as a mouse.

The display unit 230 corresponds to an LCD or a CRT that displays various kinds of information. The display unit 230 can include a touch panel provided on the surface thereof.

When the power of the normal PC 20 is turned on, according to a boot loader (a boot program) in the ROM 204, the CPU 201 of the apparatus main body 200 reads the OS from the HDD 206, loads and develops the OS into the SDRAM 203, and then activates the OS. Further, the CPU 201 loads and develops the application, the browser and the printer driver in the HDD 206 into the SDRAM 203.

In a mode of generating print data, the application on the SDRAM 203 generates print data according to the operation of the input unit 220 on the screen of the display unit 230. When a print request is issued by operating the input unit 220, the printer driver interprets (processes) the print data in a language recognizable to the MFP 10, and sends a print order including the interpreted print data and required conditions (such as a print condition and a device selecting condition) to the MFP 10 for printing. At this time, user I/F control or the input/output control (screen display and control of inputs with the keyboard, the mouse or the like) of the input unit 220 and the display unit 230 with the user is also executed.

Network control is executed using the USB I/F 208, the IEEE 1394 I/F 209, and the MAC I/F 210.

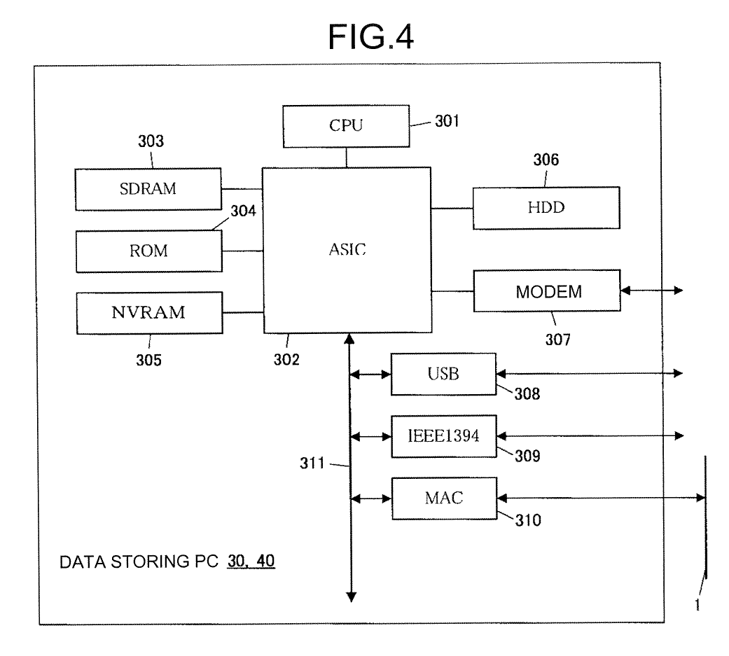

A hardware configuration example of the data storing PCs 30, 40 in FIG. 1 is specifically explained below with reference to FIG. 4.

FIG. 4 is a block diagram of the hardware configuration example of the data storing PCs 30, 40 in FIG. 1. Each of the data storing PCs 30, 40 is a data storage unit (a DB device) holding a DB (data) that can be used by the MFP 10 and the normal PC 20. As shown in FIG. 4, each of the data storing PCs 30, 40 includes a CPU 301, an ASIC 302, an SDRAM 303, a ROM 304, an NVRAM 305, an HDD 306, a modem 307, a USB I/F 308, an IEEE 1394 I/F 309, and a MAC I/F 310.

The hardware configuration of the data storing PCs 30, 40 is substantially identical to the hardware configuration of the normal PC 20 explained with reference to FIG. 3 (only without the input unit and the display unit).

The HDD 306 stores a DB that can be used by the MFP 10 or the normal PC 20. It is to be noted that the data storing PCs 30, 40 have different types of DBs. For example, the data storing PC 30 stores a DB for Windows NT if the data storing PC 30 is a Windows NT server for user registration, and the data storing PC 40 stores a DB for Unix if the data storing PC 40 is a user managing server for Unix PCs.

When the power of the data storing PC 30 is turned on, the CPU 301 reads an OS from the HDD 306, and loads and develops the OS into the SDRAM 303, and then activates the OS according to a boot loader in the ROM 304.

The CPU 301 then performs network control using the USB I/F 308, the IEEE 1394 I/F 309, and the MAC I/F 310.

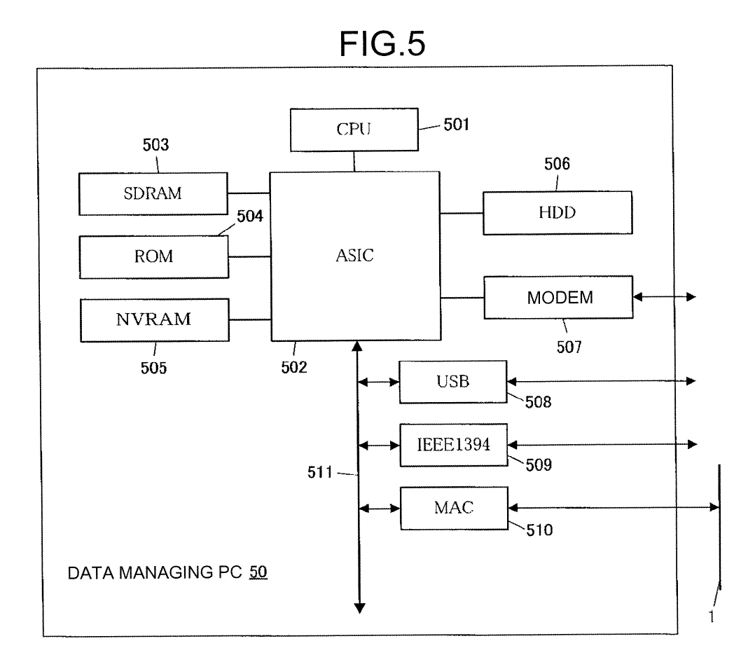

A hardware configuration example of the data managing PC 50 in FIG. 1 is specifically explained with reference to FIG. 5.

FIG. 5 is a block diagram of the hardware configuration example of the data managing PC 50 in FIG. 1. The data managing PC 50 is a data managing apparatus that manages data respectively stored in the data storing PCs 30, 40. As shown in FIG. 5, the data managing PC 50 includes a CPU 501, an ASIC 502, an SDRAM 503, a ROM 504, an NVRAM 505, an HDD 506, a modem 507, a USB I/F 508, an IEEE 1394 I/F 509, and a MAC I/F 510.

The hardware configuration of the data managing PC 50 is substantially identical to the hardware configuration of the data storing PCs 30, 40 explained with reference to Fig. 4.

When the power of the data managing PC 50 is turned on, the CPU 501 reads an OS from the HDD 506, and loads and develops the OS into the SDRAM 503, and then activates the OS according to a boot loader in the ROM 504.

The CPU 501 then performs network control using the USB I/F 508, the IEEE 1394 I/F 509, and the MAC I/F 510.

Besides the MFP 10, a single image forming apparatus such as a printer, a digital copying machine, or a FAX machine, can be connected to the data managing PC 50 over the network 1 or directly.

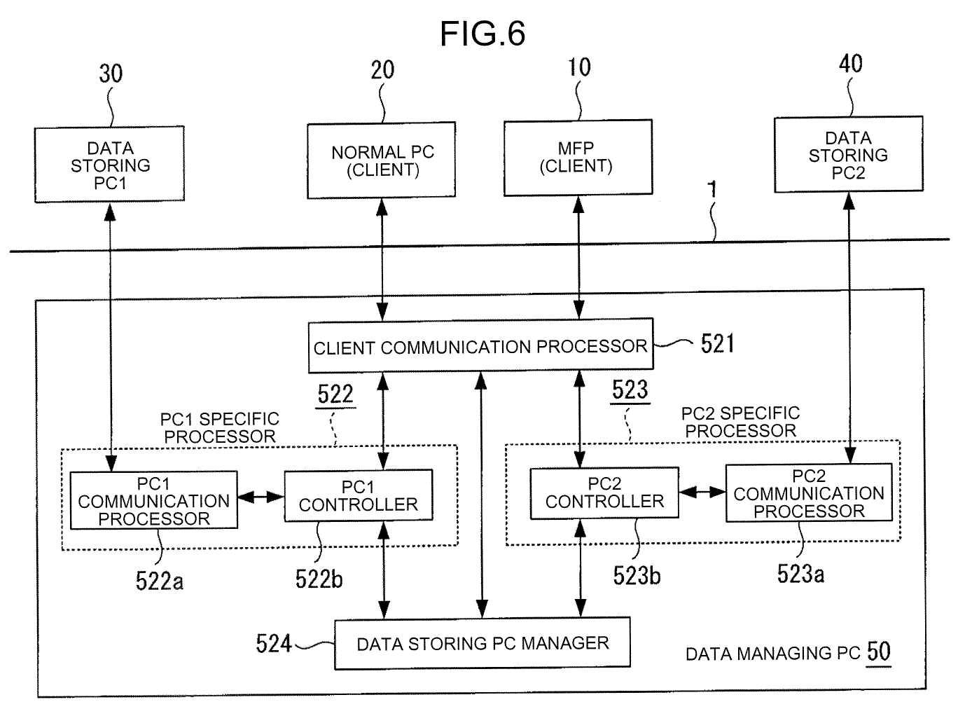

A hardware configuration example of the relevant functions of the data managing PC 50 is specifically explained below with reference to FIG. 6.

FIG. 6 is a block diagram of the hardware configuration example of the relevant functions of the data managing PC 50 in FIG. 1. The data managing PC 50 includes functions as a client communication processor 521, a PC1 specific processor 522, a PC2 specific processor 523, and a data storing PC manager 524. The functions can be achieved as the CPU 501 in FIG. 5 operates according to the program on the ROM 504 or the SDRAM 503, and selectively uses the USB I/F 508, the IEEE 1394 I/F 509, and the MAC I/F 510 as necessary. Since the data storing PCs 30, 40 respectively handle different types of data, the data storing PCs 30, 40 include respectively the PC1 specific processor 522 and the PC2 specific processor 523.

The client communication processor 521 is a first communication processing unit that communicates with the MFP 10 and the normal PC 20 over the network 1.

The PC1 specific processor 522 includes a PC1 communication processor 522a and a PC1 controller 522b. The PC1 communication processor 522a is a second communication processing unit that communicates with the data storing PC 30 (the data storing PC1) over the network 1. The PC1 controller 522b is a controller that, based on the management status of the data storing PC manager 524 (described later), converts data, such as a communication command from the data storing PC 30 that is received by the PC1 communication processor 522a to a format (a protocol) compatible (interpretable by a transmission destination) with a transmission destination (such as the data managing PC 50, the MFP 10, and the normal PC 20), and data, such as a communication command from the MFP 10 and the normal PC 20 that is received by the client communication processor 521 to a format compatible with a transmission destination (the data storing PC 30).

The PC2 specific processor 523 includes a PC2 communication processor 523a and a PC2 controller 523b. The PC2 communication processor 523a is a second communication processing unit that communicates with the data storing PC 40 (the data storing PC2) over the network 1. The PC2 controller 523b is a controller that, based on the management status of the data storing PC manager 524 (described later), converts data, such as a communication command from the data storing PC 30 that is received by the PC2 communication processor 523a to a format compatible with a transmission destination (such as the data managing PC 50, the MFP 10, and the normal PC 20), and data, such as a communication command from the MFP 10 and the normal PC 20 that is received by the client communication processor 521 to a format compatible with a transmission destination (the data storing PC 40).

The data storing PC manager 524 is an information manager that stores identification information (e.g., an IP address or a machine name) for identifying each of the data storing PCs 30, 40 or data storage units, and identification information (e.g., an IP address or a machine name) for identifying each of the MFP 10 and the normal PC 20 or data processing devices that are allowed to use the DBs (data) respectively stored in the data storing PCs 30, 40, as management data, in the HDD 506 (see FIG. 5) in association with each other.

The programs that allow the CPU 501 to achieve the function of the PC1 specific processor 522 and the function of the PC2 specific processor 523 can be downloaded externally or added by a service person.

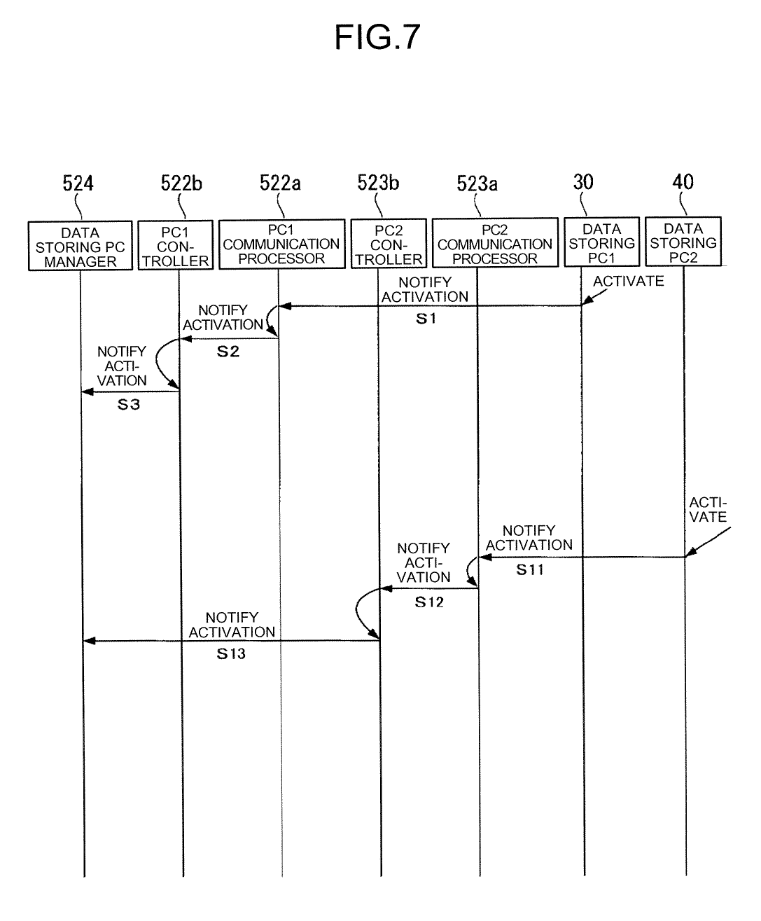

Control of the data processing system according to the invention is specifically explained below with reference to FIGS. 7 to 16.

An example of a communication sequence when the data storing PCs 30, 40 in the data processing system are activated is explained below with reference to FIG. 7.

FIG. 7 is an example of a communication sequence when the data storing PCs 30, 40 in the data processing system are activated. In FIG. 7 and the following diagrams, steps are abbreviated as “S”.

When activated (when the power is turned on), the data storing PC 30 (the data storing PC1) sends an activation notification (including identification information of the data storing PC 30) notifying the activation thereof to the data managing PC 50 over the network 1 (S1).

Upon reception of the activation notification from the data storing PC 30, the PC1 communication processor 522a of the data managing PC 50 sends the activation notification to the PC1 controller 522b (S2).

Upon reception of the activation notification from the PC1 communication processor 522a, the PC1 controller 522b converts the activation notification to a format compatible with the data managing PC 50 (interpretable in the data managing PC 50), and then sends the converted activation notification to the data storing PC manager 524 (S3).

Upon reception of the activation notification from the PC1 controller 522b, the data storing PC manager 524 acknowledges from the identification information included in the activation notification that the data storing PC 30 or the communication destination has been activated, and stores information indicating that the data storing PC 30 is available (e.g., a corresponding flag) in the HDD 506 in association with the identification information (e.g., an IP address and a machine name) of the data storing PC 30.

When activated, the data storing PC 40 (the data storing PC2) likewise sends an activation notification (including identification information of the data storing PC 40) notifying the activation thereof to the data managing PC 50 over the network 1 (S11).

Upon reception of the activation notification from the data storing PC 40, the PC2 communication processor 523a of the data managing PC 50 performs a process similar to the one performed by the PC2 communication processor 523a (S12), and the PC2 controller 523b likewise performs a process similar to the one performed by the PC1 controller 522b (S13).

Upon reception of the activation notification from the PC2 controller 523b, the data storing PC manager 524 acknowledges from the identification information included in the activation notification that the data storing PC 40 or the communication destination has been activated, and stores information indicating that the data storing PC 40 is available in the HDD 506 in association with the identification information of the data storing PC 40.

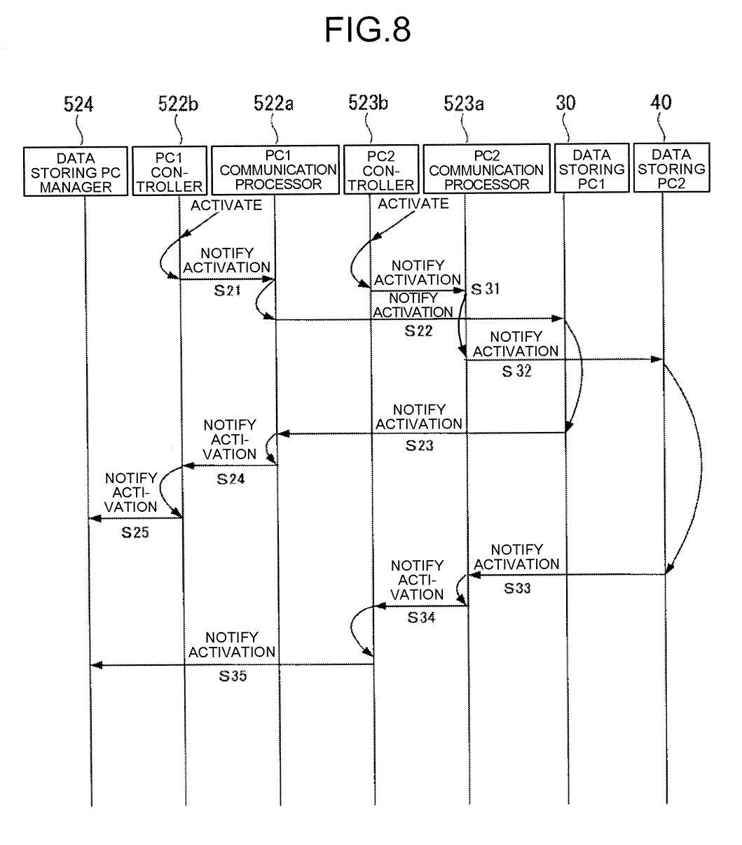

An example of a communication sequence when the data managing PC 50 in the data processing system is activated is explained below with reference to FIG. 8.

FIG. 8 is an example of a communication sequence when the data managing PC 50 in the data processing system is activated.

When the data managing PC 50 is activated, the PC1 controller 522b of the data managing PC 50 sends an activation notification (including identification information of the data managing PC 50) notifying the activation thereof to the PC1 communication processor 522a in a format compatible with the data storing PC 30 (S21).

Upon reception of the activation notification from the PC1 controller 522b, the PC1 communication processor 522a sends the activation notification to the data storing PC 30 over the network 1 (S22).

Upon reception of the activation notification from the data managing PC 50 during activation of the data storing PC 30, the data storing PC 30 acknowledges from the identification information included in the activation notification that the data managing PC 50 or the communication destination has been activated, and sends an activation notification (including identification information of the data storing PC 30) notifying the activation thereof to the data managing PC 50 over the network 1 (S23).

When the data managing PC 50 is activated, the PC2 controller 523b of the data managing PC 50 sends an activation notification (including identification information of the data managing PC 50) notifying the activation thereof to the PC2 communication processor 523a in a format compatible with the data storing PC 40 (S31).

Upon reception of the activation notification from the PC1 controller 523b, the PC1 communication processor 523a sends the activation notification to the data storing PC 40 over the network 1 (S32).

Upon reception of the activation notification from the data managing PC 50 during activation of the data storing PC 40, the data storing PC 40 acknowledges from the identification information included in the activation notification that the data managing PC 50 or the communication destination has been activated, and sends an activation notification (including identification information of the data storing PC 40) notifying the activation thereof to the data managing PC 50 over the network 1 (S33).

Upon reception of the activation notification from the data storing PC 30, the PC1 communication processor 522a of the data managing PC 50 performs a process similar to the one explained with reference to FIG. 7 (S24), and the PC1 controller 522b likewise performs a process similar to the one explained with reference to FIG. 7 (S25).

Upon reception of the activation notification from the data storing PC 40, the PC2 communication processor 523a of the data managing PC 50 performs a process similar to the one explained with reference to FIG. 7 (S34), and the PC2 controller 523b likewise performs a process similar to the one explained with reference to FIG. 7 (S35).

Upon reception of the activation notification from each of the PC1 controller 522b and the PC2 controller 523b, the data storing PC manager 524 performs a process similar to the one explained with reference to FIG. 7.

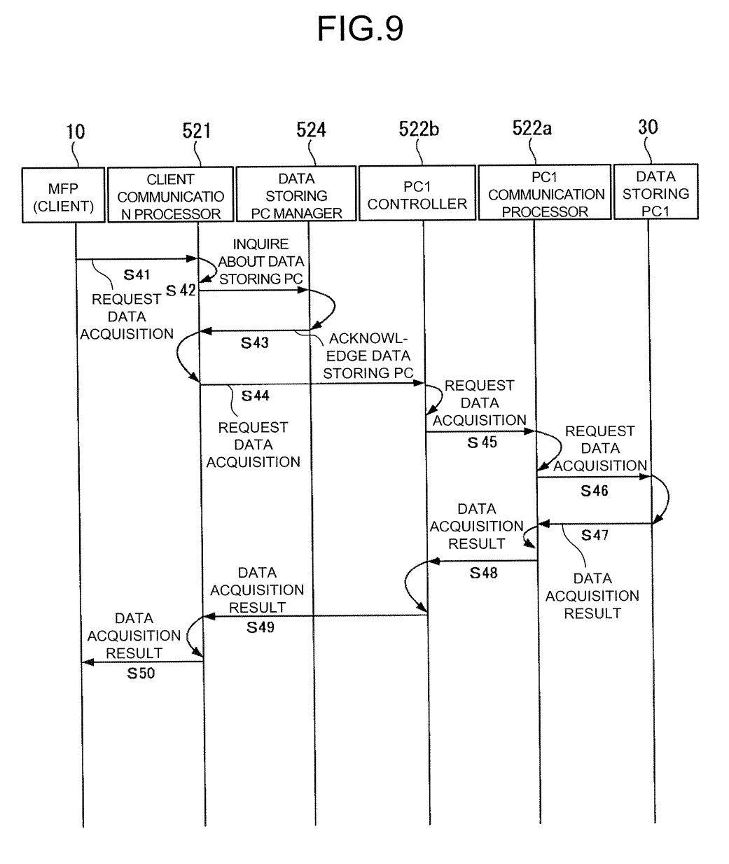

An example of a communication sequence when a data acquisition request is generated by the MFP 10 in the data processing system is explained below with reference to FIG. 9.

FIG. 9 is an example of a communication sequence when a data acquisition request is generated by the MFP 10 in the data processing system.

When an acquisition request for some data is generated by a key operation on the operating unit 107, the MFP 10 sends a corresponding data acquisition request (including identification information for identifying the MFP 10 and identification information for identifying data to be acquired) to the data managing PC 50 over the network 1 (S41).

Upon reception of the data acquisition request from the MFP 10, the client communication processor 521 of the data managing PC 50 does not recognize a data storing PC of the communication destination or a data storing PC storing data which the MFP 10 can use, and inquires the data storing PC manager 524 about the data storing PC (S42).

In response to the inquiry, the data storing PC manager 524 searches for the data storing PC (the data storing PC 30 in this example) holding data which the MFP 10 can use, based on the management data in the HDD 506, and returns the search result to the client communication processor 521 (S43).

As a result, the client communication processor 521 recognizes that the data storing PC holding data which the MFP 10 can use is the data storing PC 30, and thus sends the data acquisition request to the PC1 controller 522b to ensure communication with the data storing PC 30 (S44).

Upon reception of the data acquisition request from the client communication processor 521, the PC1 controller 522b converts the data acquisition request to a format compatible with the data storing PC 30 or the transmission destination (interpretable in the data storing PC 30), and then sends the converted data acquisition request to the PC1 communication processor 522a (S45).

Upon reception of the data acquisition request from the PC1 controller 522b, the PC1 communication processor 522a sends the data acquisition request to the data storing PC 30 over the network 1 (S46).

When receiving the data acquisition request from the data managing PC 50, the data storing PC 30 recognizes from each identification information included therein that the sender of the data acquisition request is the MFP 10 and data to be acquired, the data storing PC 30 reads the data from the local DB and sends the data (including identification information of the data storing PC 30) as a data acquisition result to the data managing PC 50 over the network 1 (S47).

Upon reception of the data acquisition result from the data storing PC 30 in response to the data acquisition request sent to the data storing PC 30, the PC1 communication processor 522a of the data managing PC 50 sends the data acquisition result to the PC1 controller 522b (S48).

Upon reception of the data acquisition result from the PC1 communication processor 522a, the PC1 controller 522b converts the data acquisition result to a format compatible with the data managing PC 50 (interpretable in the data managing PC 50), namely, in a format that can be used by the MFP 10 and the normal PC 20, and then sends the converted data acquisition result to the client communication processor 521 (S49).

Upon reception of the data acquisition result from the PC1 controller 522b, the client communication processor 521 sends the data acquisition result to the MFP 10 or the sender of the data acquisition request over the network 1 (S50).

When receiving (acquiring) the data acquisition result (data) from the data managing PC 50, the MFP 10 writes the data acquisition result in the HDD 106. That is, the MFP 10 updates data in the HDD 106 (e.g., a program like firmware) based on the received data.

When the MFP 10 acquires data from the data storing PC 40 in response to a data acquisition request made to the data storing PC 40, the client communication processor 521, the PC2 communication processor 523a, the PC2 controller 523b, and the data storing PC manager 524 of the data managing PC 50, and the data storing PC 40 perform corresponding processes. Of the processes, those performed by the PC2 communication processor 523a, the PC2 controller 523b, and the data storing PC 40 are similar to the processes performed by the PC1 communication processor 522a, the PC1 controller 522b, and the data storing PC 30.

When the normal PC 20 acquires data from the data storing PC 30 or 40 in response to a data acquisition request made to the data storing PC 30 or 40, the data managing PC 50 and the data storing PCs 30, 40 likewise perform processes almost similar to those performed by the MFP 10 to make a data acquisition request to the data storing PC 30 or 40 to acquire data therefrom.

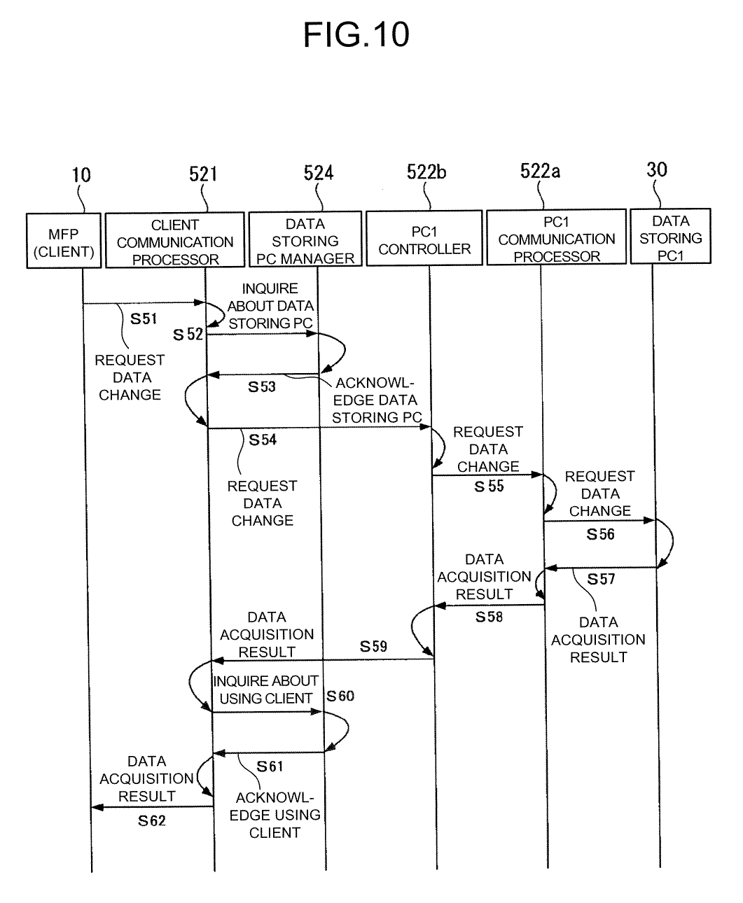

An example of a communication sequence when a data change request is generated by the MFP 10 in the data processing system is explained below with reference to FIG. 10.

FIG. 10 is an example of a communication sequence when a data change request is generated by the MFP 10 in the data processing system.

When a request to change some data is generated by a key operation on the operating unit 107, the MFP 10 sends a corresponding data change request (including identification information for identifying the MFP 10 and identification information for identifying data to be changed) to the data managing PC 50 over the network 1 (S51).

Upon reception of the data change request from the MFP 10, the client communication processor 521 of the data managing PC 50 does not recognize a data storing PC of the communication destination or a data storing PC storing data which the MFP 10 can use, and inquires the data storing PC manager 524 about the data storing PC (S52).

In response to the inquiry, the data storing PC manager 524 searches for the data storing PC (data storing PC 30 in this example) holding data which the MFP 10 can use based on the management data in the HDD 506, and returns the search result to the client communication processor 521 (S53).

As a result, the client communication processor 521 recognizes that the data storing PC holding data which the MFP 10 can use is the data storing PC 30, and thus sends the data change request to the PC1 controller 522b to ensure communication with the data storing PC 30 (S54).

Upon reception of the data change request from the client communication processor 521, the PC1 controller 522b converts the data change request to a format compatible with the data storing PC 30 or the transmission destination (interpretable in the data storing PC 30), and then sends the converted data change request to the PC1 communication processor 522a (S55).

Upon reception of the data change request from the PC1 controller 522b, the PC1 communication processor 522a sends the data change request to the data storing PC 30 over the network 1 (S56).

When receiving the data change request from the data managing PC 50, the data storing PC 30 recognizes from each identification information included therein that the sender of the data change request is the MFP 10 and data to be changed, the data storing PC 30 changes the data in the local DB according to the contents of the change included in the data change request, and sends the data change result (including identification information of the data storing PC 30) to the data managing PC 50 over the network 1 (S57).

Upon reception of the data change result from the data storing PC 30 in response to the data change request sent to the data storing PC 30, the PC1 communication processor 522a of the data managing PC 50 sends the data change result to the PC1 controller 522b (S58).

Upon reception of the data change result from the PC1 communication processor 522a, the PC1 controller 522b converts the data change result to a format compatible with the data managing PC 50 (interpretable in the data managing PC 50), namely, in a format that can be used by the MFP 10 and the normal PC 20, and then sends the converted data change result to the client communication processor 521 (S59).

When receiving the data change request from the PC1 controller 522b, the client communication processor 521 inquires the data storing PC manager 524 about any client (a data processing device) that has been able to use data before change for such clients are not limited to the MFP 10 alone (S60).

In response to the inquiry, the data storing PC manager 524 searches for those clients which have been able to use data before change based on the management data in the HDD 506, and returns the search result to the client communication processor 521 (S61).

The client communication processor 521 recognizes those clients which could use data before change from the search result, and thus sends the data change result to the clients (only the MFP 10 in the example) over the network 1 (S62). Of course, when the normal PC 20 is included in the clients that could use data before change, the client communication processor 521 also sends the data change result to the normal PC 20 over the network 1.

Upon reception of the data change result from the data managing PC 50, the MFP 10 displays the contents on the operating unit 107 in FIG. 2. When the normal PC 20 receives the data change result from the data managing PC 50, the normal PC 20 displays the contents on the display unit 230 in FIG. 3.

When the MFP 10 changes data in the DB in the data storing PC 40 in response to a data change request made to the data storing PC 40, the client communication processor 521, the PC2 communication processor 523a, the PC2 controller 523b, and the data storing PC manager 524 of the data managing PC 50, and the data storing PC 40 perform corresponding processes. Of the processes, those performed by the PC2 communication processor 523a, the PC2 controller 523b, and the data storing PC 40 are similar to the processes performed by the PC1 communication processor 522a, the PC1 controller 522b, and the data storing PC 30.

When the normal PC 20 changes data in the DB in the data storing PC 30 or 40 in response to a data change request made to the data storing PC 30 or 40, the data managing PC 50 and the data storing PCs 30, 40 likewise perform processes almost similar to those performed by the MFP 10 to make a data change request to the data storing PC 30 or 40 to change data in the DB therein.

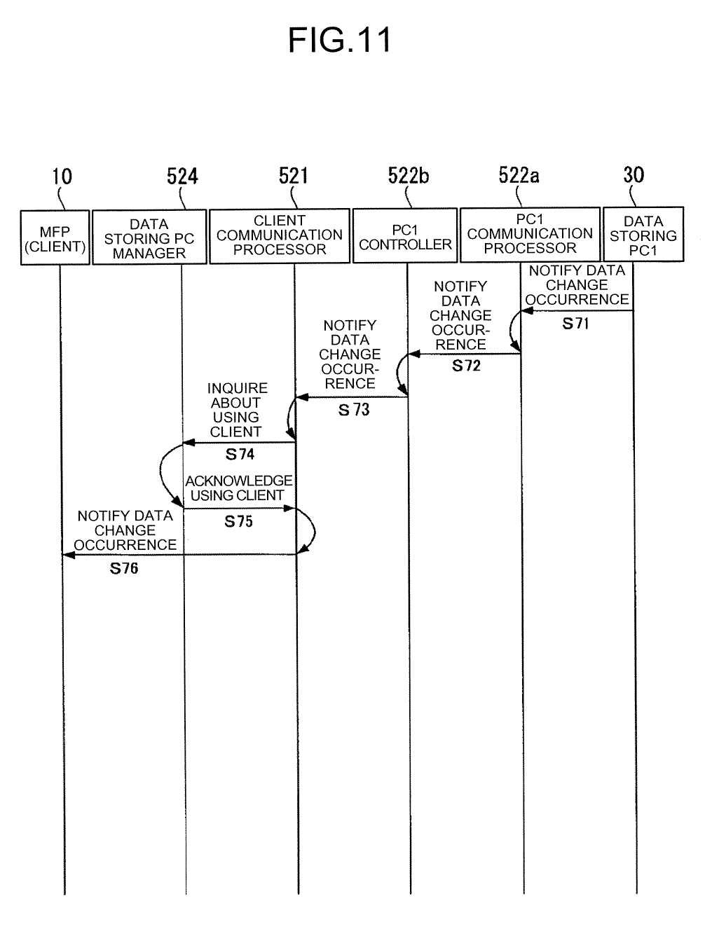

An example of a communication sequence when a data change occurrence notification is sent from the data storing PC 30 in the data processing system is explained below with reference to FIG. 11.

FIG. 11 is an example of a communication sequence when a data change occurrence notification is sent from the data storing PC 30 in the data processing system.

When data in the DB in the data storing PC 30 is changed by the operation of an exclusive device of a service person (a portable terminal such as a notebook PC), the data storing PC 30 sends a data change occurrence notification (including identification information of the data storing PC 30) notifying the change to the data managing PC 50 over the network 1 (S71).

Upon reception of the data change occurrence notification from the data storing PC 30, the PC1 communication processor 522a of the data managing PC 50 sends the data change occurrence notification to the PC1 controller 522b (S72).

Upon reception of the data change occurrence notification from the PC1 communication processor 522a, the PC1 controller 522b converts the data change occurrence notification to a format compatible with the data managing PC 50 (interpretable in the data managing PC 50), namely, a format compatible with the MFP 10 and the normal PC 20 (interpretable in the MFP 10 and the normal PC 20), and then sends the converted data change occurrence notification to the client communication processor 521 (S73).

Upon reception of the data change occurrence notification from the PC1 controller 522b, the client communication processor 521 does not recognize a communicating client that has been able to use data before change, and inquires the data storing PC manager 524 about the client (S74).

In response to the inquiry, the data storing PC manager 524 searches for the communicating client that has been able to use data before change based on the management data in the HDD 506, and returns the search result to the client communication processor 521 (S75).

The client communication processor 521 recognizes those clients which could use data before change from the search result, and thus sends the data change occurrence notification to the clients (only the MFP 10 in the example) over the network 1 (S76). Of course, when the normal PC 20 is included in the clients that could use data before change, the client communication processor 521 also sends the data change occurrence notification to the normal PC 20 over the network 1.

Upon reception of the data change occurrence notification from the data managing PC 50, the MFP 10 displays the contents on the operating unit 107 in FIG. 2. When the normal PC 20 receives the data change occurrence notification from the data managing PC 50, the normal PC 20 displays the contents on the display unit 230 in FIG. 3.

When the data storing PC 40 has sent the data change occurrence notification, the client communication processor 521, the PC2 communication processor 523a, the PC2 controller 523b, and the data storing PC manager 524 of the data managing PC 50 perform corresponding processes. Of the processes, those performed by the PC2 communication processor 523a and the PC2 controller 523b are similar to the processes performed by the PC1 communication processor 522a and the PC1 controller 522b.

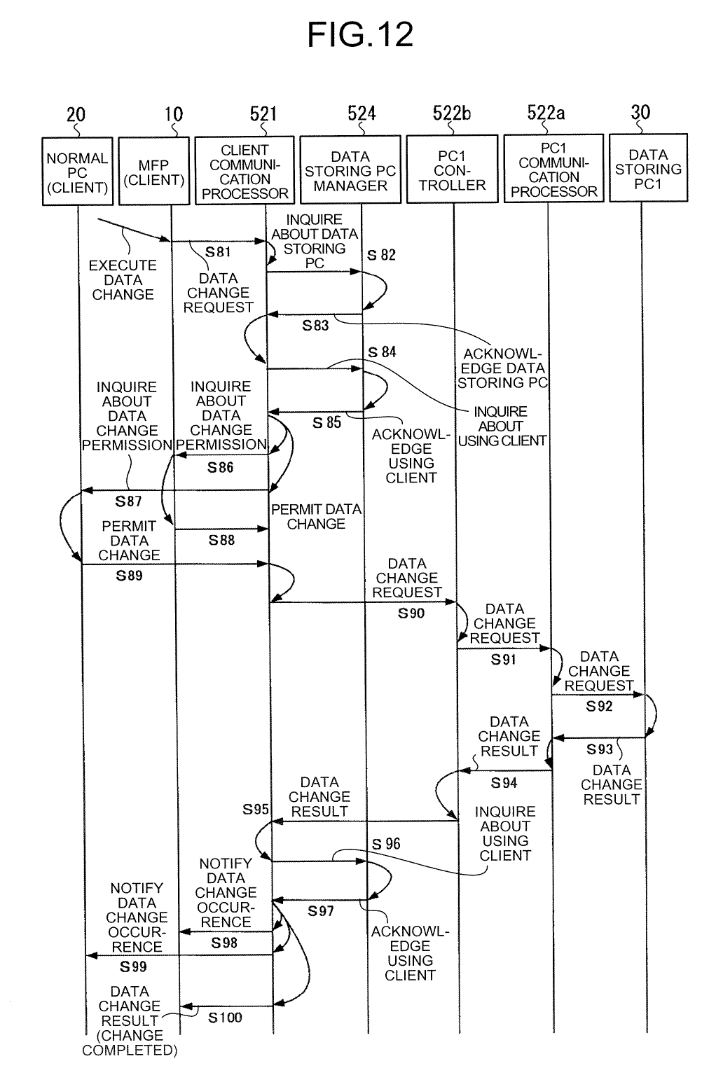

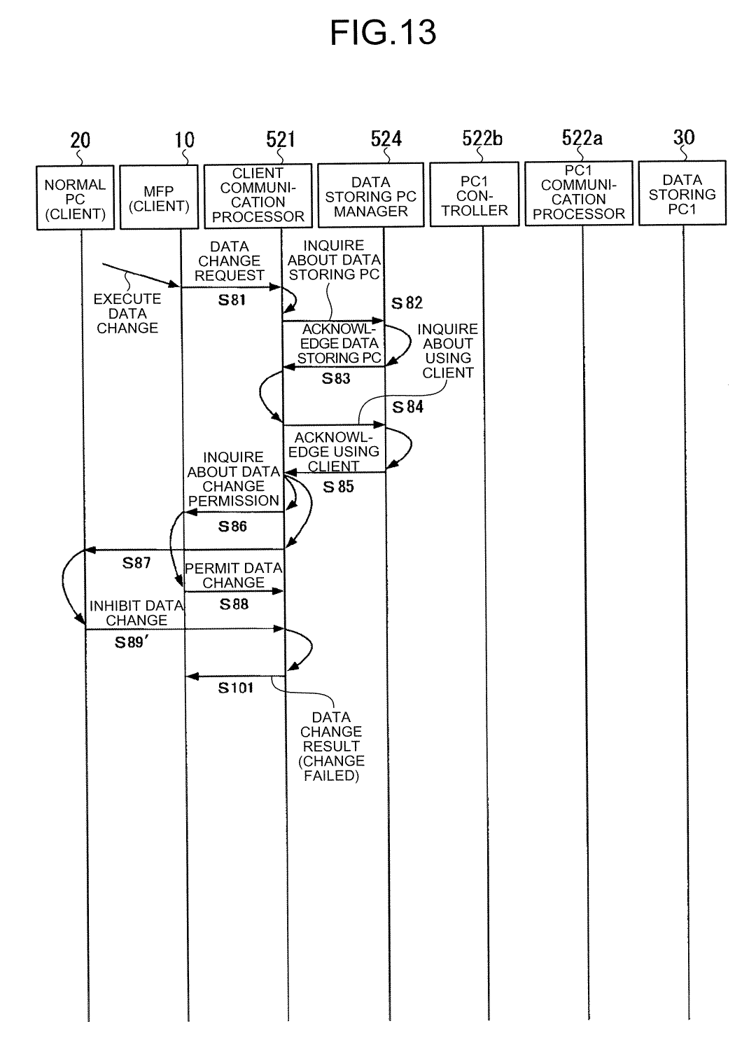

Other examples of a communication sequence when a data change request is generated by the MFP 10 in the data processing system (examples of the communication sequence when a data change is permitted and when a data change is not permitted are explained below with reference to FIGS. 12 and 13.

FIG. 12 is an example of a communication sequence when a data change request is generated by the MFP 10 in the data processing system and a data change is permitted.

FIG. 13 is an example of a communication sequence when a data change request is generated by the MFP 10 in the data processing system and a data change is not permitted.

When a request to change some data is generated by a key operation on the operating unit 107, the MFP 10 sends a corresponding data change request (including identification information for identifying the MFP 10 and identification information for identifying data to be changed) to the data managing PC 50 over the network 1 (S81 in FIG. 12).

Upon reception of the data change request from the MFP 10, the client communication processor 521 of the data managing PC 50 does not recognize a data storing PC of the communication destination or a data storing PC storing data which the MFP 10 can use, and inquires the data storing PC manager 524 about the data storing PC (S82).

In response to the inquiry, the data storing PC manager 524 searches for the data storing PC (the data storing PC 30 in this example) holding data which the MFP 10 can use, based on the management data in the HDD 506, and returns the search result to the client communication processor 521 (S83).

As a result, the client communication processor 521 recognizes that the data storing PC holding data which the MFP 10 can use is the data storing PC 30.

Because data (data before change) usable by the MFP 10 can be usable by other clients than the MFP 10, an inquiry about clients that can use the data is made to the data storing PC manager 524 (S84).

In response to the inquiry, the data storing PC manager 524 searches for clients that can use the data before change based on the management data in the HDD 506, and returns the search result to the client communication processor 521 (S85).

As a result, the client communication processor 521 knows all the clients that can use data before change, and sequentially inquires the MFP 10 and the normal PC 20 whether to change data (data change permission) when the clients are the MFP 10 and the normal PC 20 (S86, S87).

In response to the inquiry, the MFP 10 checks if a data change can be done, and sends the check result to the data managing PC 50. For example, when message information indicating whether a data change should be done is displayed on the operating unit 107 in FIG. 2, and an operation to permit a data change is performed on the display of the message information, a notification to permit a data change is sent to the data managing PC 50 (S88). When an operation to inhibit a data change is performed, a notification to inhibit a data change is sent to the data managing PC 50.

In response to the inquiry, the normal PC 20 likewise checks if a data change can be done, and sends the check result to the data managing PC 50. For example, when message information indicating whether a data change should be done is displayed on the display unit 230 in FIG. 3, and an operation to permit a data change is performed on the input unit 220, a notification to permit a data change is sent to the data managing PC 50 (S89). When an operation to inhibit a data change is performed on the input unit 220, a notification to inhibit a data change is sent to the data managing PC 50 (S89′ in FIG. 13).

When receiving notifications to permit a data change from all the clients that can use data before change, namely the MFP 10 and the normal PC 20, the client communication processor 521 of the data managing PC 50 can perform a data changing process, and therefore sends the data change request received from the MFP 10 to the PC1 controller 522b to ensure communication with the data storing PC 30 (S90).

Upon reception of the data change request from the client communication processor 521, the PC1 controller 522b converts the data change request to a format compatible with the data storing PC 30 or the transmission destination, and then sends the converted data change request to the PC1 communication processor 522a (S91).

Upon reception of the data change request from the PC1 controller 522b, the PC1 communication processor 522a sends the data change request to the data storing PC 30 over the network 1 (S92).

When receiving the data change request from the data managing PC 50, the data storing PC 30 recognizes from each identification information included therein that the sender of the data change request is the MFP 10 and data to be changed, the data storing PC 30 changes the data in the local DB according to the contents of the change included in the data change request, and sends the data change result (including identification information of the data storing PC 30) to the data managing PC 50 over the network 1 (S93).

Upon reception of the data change result from the data storing PC 30 in response to the data change request sent to the data storing PC 30, the PC1 communication processor 522a of the data managing PC 50 sends the data change result to the PC1 controller 522b (S94).

Upon reception of the data change result from the PC1 communication processor 522a, the PC1 controller 522b converts the data change result to a format compatible with the data managing PC 50, namely, in a format that can be used by the MFP 10 and the normal PC 20, and then sends the converted data change result to the client communication processor 521 (S95).

When receiving the data change request from the PC1 controller 522b, the client communication processor 521 inquires the data storing PC manager 524 about any client that has been able to use data before change (S96).

In response to the inquiry, the data storing PC manager 524 searches for those clients which have been able to use data before change based on the management data in the HDD 506, and returns the search result to the client communication processor 521 (S97).

The client communication processor 521 recognizes from the search result that the clients that could use data before change are the MFP 10 and the normal PC 20, and thus sequentially sends the data change occurrence notification to the MFP 10 and the normal PC 20 over the network 1 (S98, S99). The data change result (change completion) received from the PC1 controller 522b is sent to the MFP 10 or the sender of the data change request (S100).

Upon reception of the data change result following the data change occurrence notification from the data managing PC 50, the MFP 10 displays the contents on the operating unit 107 in FIG. 2.

When the normal PC 20 receives the data change result from the data managing PC 50, the normal PC 20 displays the contents on the display unit 230 in FIG. 3.

When receiving a notification to inhibit a data change from the normal PC 20 among all the clients that can use data before change, as shown in FIG. 13, the client communication processor 521 of the data managing PC 50 stops the data changing process, and sends a notification indicating that a data change has failed, as a data change result, to the MFP 10 or the sender of the data change request (S101). When receiving a notification to inhibit a data change from the MFP 10, the client communication processor 521 also stops the data changing process.

Upon reception of the data change result from the data managing PC 50 (indicating that a data change has failed), the MFP 10 displays the contents on the operating unit 107.

When the MFP 10 changes data in the DB in the data storing PC 40 in response to a data change request made to the data storing PC 40, the client communication processor 521, the PC2 communication processor 523a, the PC2 controller 523b, and the data storing PC manager 524 of the data managing PC 50, and the data storing PC 40 perform corresponding processes. Of the processes, those performed by the PC2 communication processor 523a, the PC2 controller 523b, and the data storing PC 40 are similar to the processes performed by the PC1 communication processor 522a, the PC1 controller 522b, and the data storing PC 30.

When the normal PC 20 changes data in the DB in the data storing PC 30 or 40 in response to a data change request made to the data storing PC 30 or 40, the data managing PC 50 and the data storing PCs 30, 40 likewise perform processes almost similar to those performed by the MFP 10 to make a data change request to the data storing PC 30 or 40 to change data in the DB therein. It is to be noted that upon reception of a notification to inhibit a data change from the MFP 10, the client communication processor 521 stops the data changing process, and sends a notification indicating that a data change has failed, as a data change result, to the normal PC 20 or the sender of the data change request.

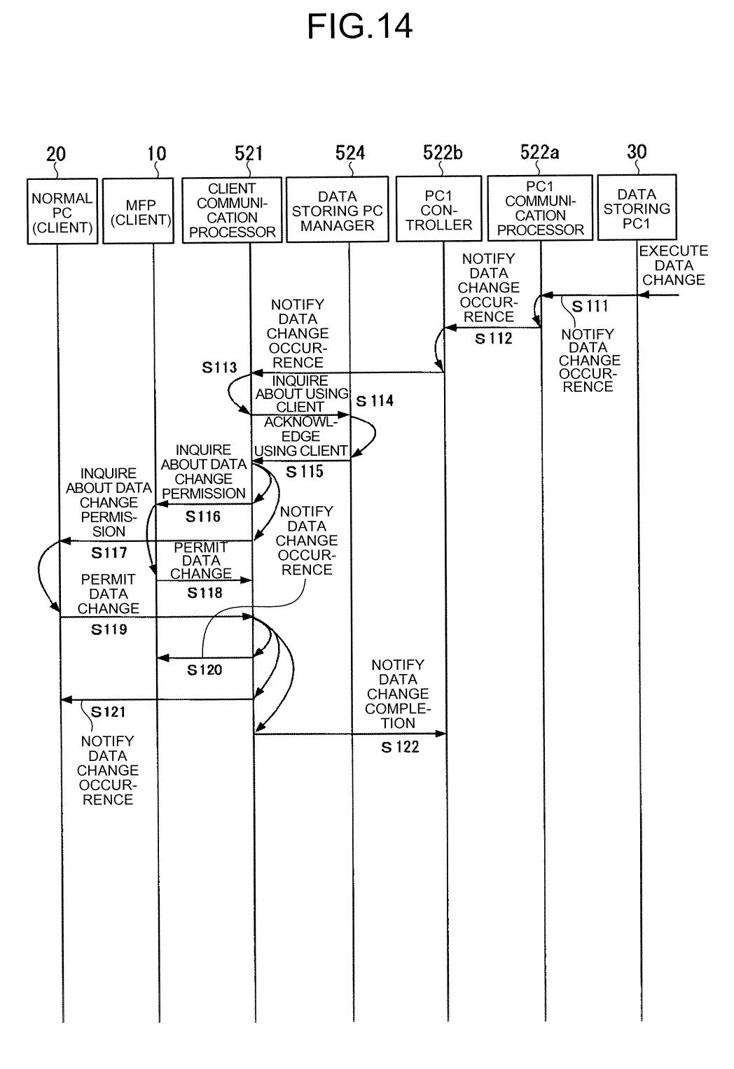

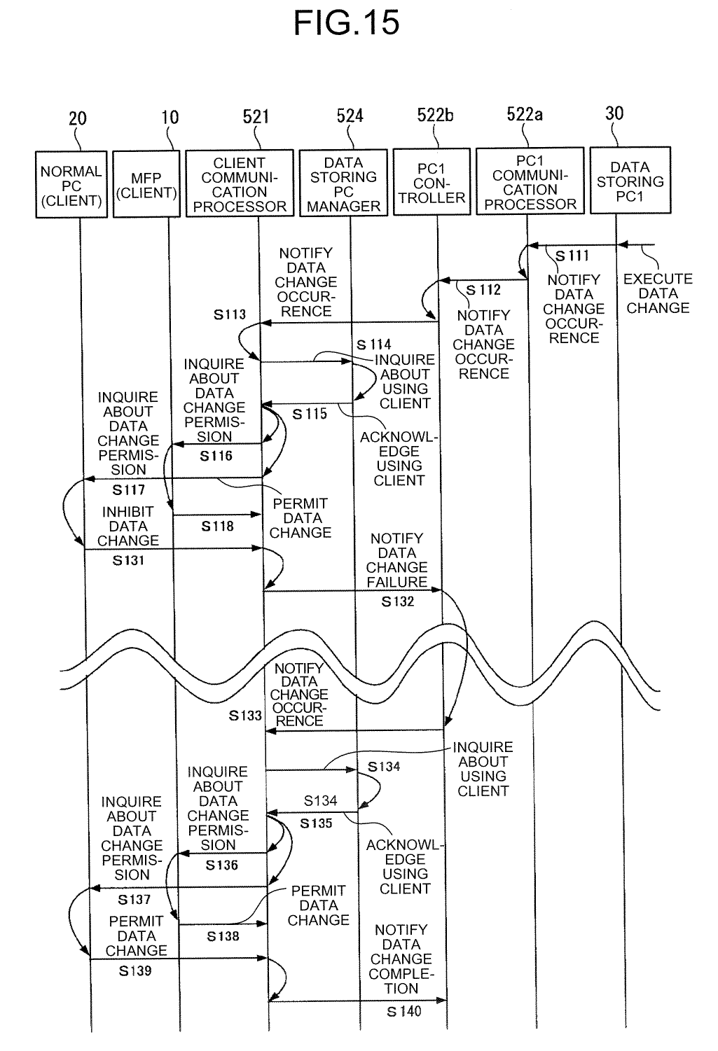

Other examples of a communication sequence when a data change occurrence notification is sent from the data storing PC 30 in the data processing system (examples of the communication sequence when a data change is permitted and when a data change is not permitted) are explained below with reference to FIGS. 14 and 15.

FIG. 14 is an example of a communication sequence when a data change occurrence notification is sent from the data storing PC 30 in the data processing system and a data change is permitted.

FIG. 15 is an example of a communication sequence when a data change occurrence notification is sent from the data storing PC 30 in the data processing system and a data change is not permitted.

When data in the DB in the data storing PC 30 is changed by the operation of an exclusive device of a service person (a portable terminal such as a notebook PC), the data storing PC 30 sends a data change occurrence notification (including identification information of the data storing PC 30) notifying the change to the data managing PC 50 over the network 1 (S111).

Upon reception of the data change occurrence notification from the data storing PC 30, the PC1 communication processor 522a of the data managing PC 50 sends the data change occurrence notification to the PC1 controller 522b (S112).

Upon reception of the data change occurrence notification from the PC1 communication processor 522a, the PC1 controller 522b converts the data change occurrence notification to a format compatible with the data managing PC 50 (interpretable in the data managing PC 50), namely, a format compatible with the MFP 10 and the normal PC 20 (interpretable in the MFP 10 and the normal PC 20), and then sends the converted data change occurrence notification to the client communication processor 521 (S113). The PC1 communication processor 522a stores information indicating occurrence of a data change (including information on an incomplete data change) in the HDD 506 in association with the identification information of the data storing PC 30.

Upon reception of the data change occurrence notification from the PC1 controller 522b, the client communication processor 521 does not recognize a communicating client that has been able to use data before change, and inquires the data storing PC manager 524 about the client (S114).

In response to the inquiry, the data storing PC manager 524 searches for the communicating client that has been able to use data before change based on the management data in the HDD 506, and returns the search result to the client communication processor 521 (S115).

As a result, the client communication processor 521 knows all the clients that can use data before change, and sequentially inquires the MFP 10 and the normal PC 20 whether to change data (data change permission) when the clients are the MFP 10 and the normal PC 20 (S116, S117).

In response to the inquiry, the MFP 10 checks if a data change can be done, and sends the check result (including identification information of the MFP 10) to the data managing PC 50. For example, when message information indicating whether a data change should be done is displayed on the operating unit 107 in FIG. 2, and an operation to permit a data change is performed on the display of the message information, a notification to permit a data change is sent to the data managing PC 50 (S118). When an operation to inhibit a data change is performed, a notification to inhibit a data change is sent to the data managing PC 50.

In response to the inquiry, the normal PC 20 likewise checks if a data change can be done, and sends the check result (including identification information of the normal PC 20) to the data managing PC 50. For example, when message information indicating whether a data change should be done is displayed on the display unit 230 in FIG. 3, and an operation to permit a data change is performed on the input unit 220, a notification to permit a data change is sent to the data managing PC 50 (S119). When an operation to inhibit a data change is performed on the input unit 220, a notification to inhibit a data change is sent to the data managing PC 50 (S131 in FIG. 15).

When receiving notifications to permit a data change from all the clients that can use data before change, namely the MFP 10 and the normal PC 20, the client communication processor 521 of the data managing PC 50 can change data. Therefore, the client communication processor 521 sequentially sends the data change occurrence notification received from the PC1 controller 522b to the MFP 10 and the normal PC 20, and then sends a notification indicating the completion of a data change (data change completion notification) to the PC1 controller 522b (S120 to S122).

Upon reception of the notification of the completion of a data change from the client communication processor 521, the PC1 controller 522b stores information indicating that a data change has been completed normally in place of information indicating occurrence of a change in data stored in the HDD 506 in association with the identification information of the data storing PC 30 (including information on an incomplete data change).

Upon reception of the data change occurrence notification from the data managing PC 50, the MFP 10 displays the contents on the operating unit 107 in FIG. 2.

Upon reception of the data change occurrence notification from the data managing PC 50, the normal PC 20 likewise displays the contents on the display unit 230 in FIG. 3.

When receiving a notification to inhibit a data change from the normal PC 20 among all the clients that can use data before change, as shown in FIG. 15, the client communication processor 521 of the data managing PC 50 sends a notification indicating that a data change has failed (including identification information of the normal PC 20) to the PC1 controller 522b (S132).

Upon reception of the notification of a failure of a data change from the client communication processor 521, the PC1 controller 522b stores information indicating that a data change has failed (including identification information of the normal PC 20) in place of information indicating occurrence of a change in data stored in the HDD 506 in association with the identification information of the data storing PC 30 (including information on an incomplete data change), and starts measuring the time.

When the information indicating that a data change has failed includes identification information of the normal PC 20 as user information, the PC1 controller 522b sends a notification indicating that a data change has failed to the client communication processor 521. This causes the notification indicating that a data change has failed to be sent to the normal PC 20 or the sender of the data acquisition request, so that displaying the contents of the notification on the normal PC 20 can allow the user thereof to know a reason why data acquisition cannot be performed.

When a predetermined time elapses since initiation of the time measurement, the PC1 controller 522b sends again a data change occurrence notification received from the PC1 communication processor 522a to a format compatible with the data managing PC 50 to the client communication processor 521 (S133). This process (a polling process) is repeated every time the PC1 controller 522b receives a notification indicating that a data change has failed from the client communication processor 521.

Since the client communication processor 521 and the data storing PC manager 524 perform processes similar to those of S114 to S117 through the polling process (S134 to S137), and receive notifications to permit a data change from all the clients that can use data before change, namely the MFP 10 and the normal PC 20, the client communication processor 521 and the data storing PC manager 524 can change data. Therefore, although not shown, the client communication processor 521 and the data storing PC manager 524 sequentially send the data change occurrence notification received from the PC1 controller 522b to the MFP 10 and the normal PC 20, and then send a notification indicating the completion of a data change (data change completion notification) to the PC1 controller 522b (S140).

Upon reception of the notification of the completion of a data change from the client communication processor 521, the PC1 controller 522b stores information indicating that a data change has been completed normally in place of information indicating that a data change stored in the HDD 506 in association with the identification information of the data storing PC 30 has failed.

When the data storing PC 40 sends a data change occurrence notification, the client communication processor 521, the PC2 communication processor 523a, the PC2 controller 523b, and the data storing PC manager 524 of the data managing PC 50 perform corresponding processes. Of the processes, those performed by the PC2 communication processor 523a, and the PC2 controller 523b are similar to the processes performed by the PC1 communication processor 522a, and the PC1 controller 522b.

Since the connection processor (connection processing software) in the data managing PC 50 includes the client communication processor 521 (the first communication processing unit), the PC1 specific processor 522 (the PC1 communication processor 522a (the second communication processing unit), and the PC1 controller 522b (the controller)), the PC2 specific processor 523 (the PC2 communication processor 523a (the second communication processing unit) and the PC2 controller 523b (the controller)), and the data storing PC manager 524 (the information manager), a process of connecting to a data storing PC extended on the network 1 or a process of connecting to a changed data storing PC on the network 1 can be executed merely by extending or changing only the PC specific processor (including the PC communication processor and the PC controller) or means (software) for executing the connection processes.

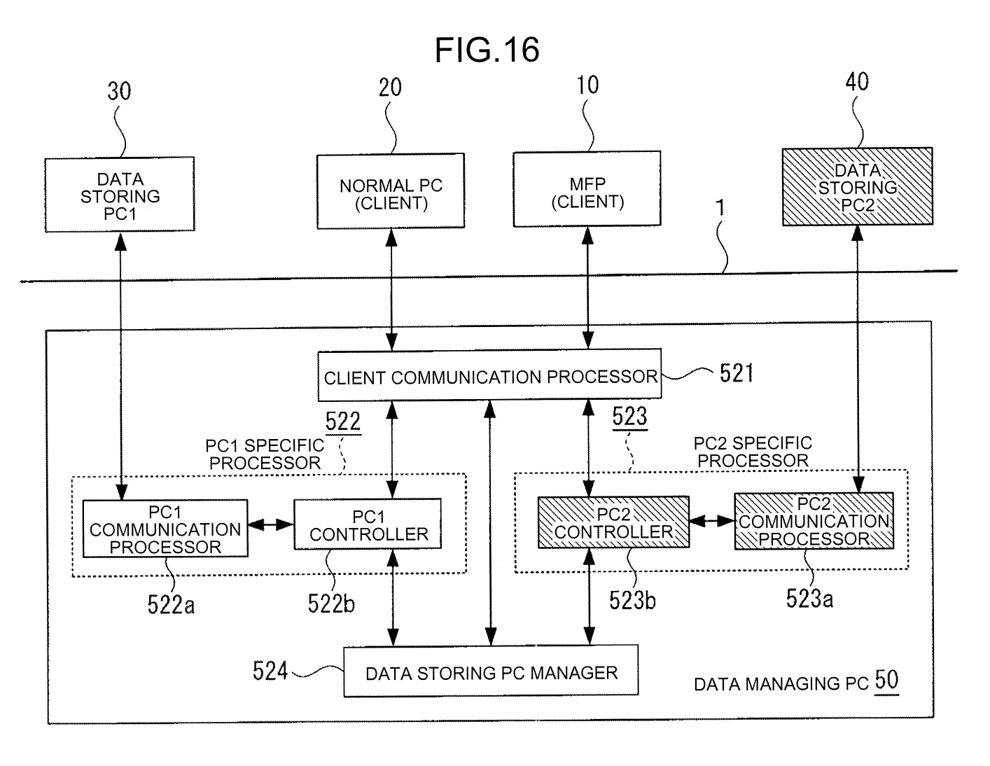

As indicated by hatched lines in FIG. 16, for example, when the data storing PC 40 on the network 1 is changed, merely changing the PC2 specific processor 523 to a PC2 specific processor for performing a process of connecting to the data storing PC 40 changed can allow clients (data processing devices) to share data (DB) stored in the changed data storing PC 40 without involving a significant cost increase. In addition, a client that can use data stored in the changed data storing PC 40 does not need to recognize that the PC2 specific processor 523 has been changed, leading to a reduction in development cost and improvement on usability.

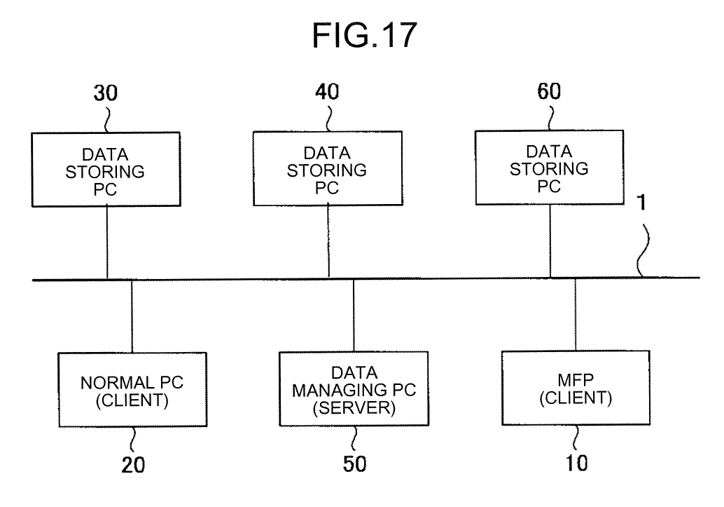

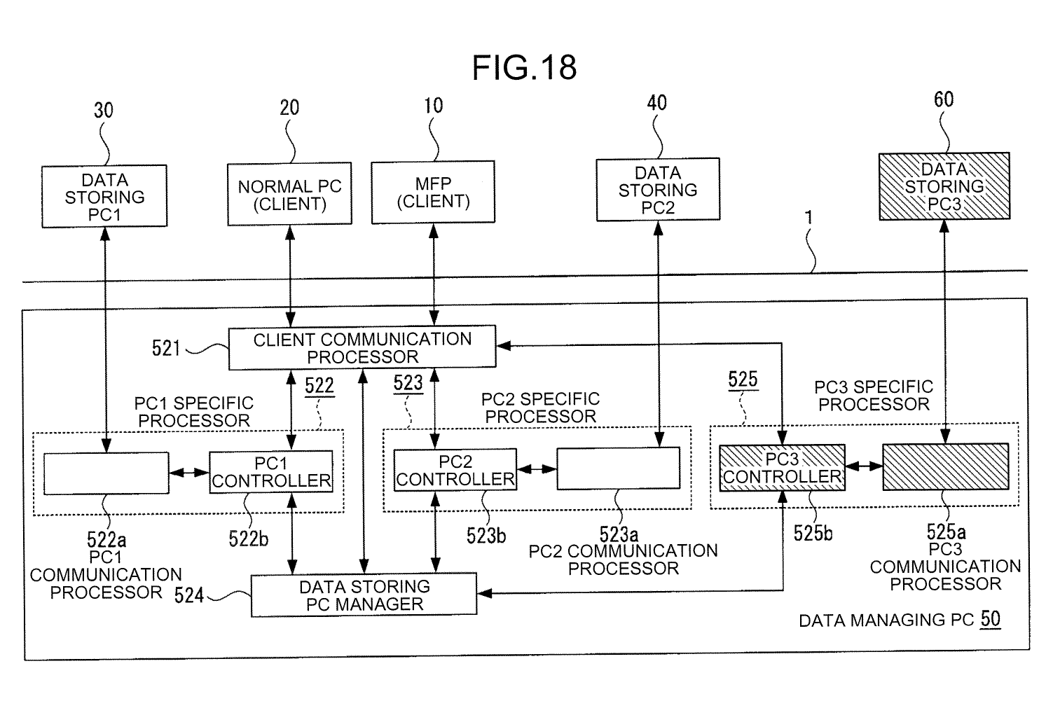

When a data storing PC 60 is extended on the network 1, as shown in FIG. 17, clients can share data stored in the extended data storing PC 60 without involving a significant cost increase by merely adding a PC3 specific processor 525 (including a PC3 communication processor 525a and a PC3 controller 525b) for performing a process of connecting to the data storing PC 60 as indicated by hatched lines in FIG. 18. In addition, a client that can use data stored in the extended data storing PC 60 does not need to recognize that the PC3 specific processor 525 has been added, leading to a reduction in development cost and improvement on usability.

Therefore, a plurality of clients can share data stored in a data storing PC extended on the network 1 or a changed data storing PC on the network 1 without involving a significant cost increase, thus ensuring cost reduction of the data processing system.

Although the client communication processor is communicable with a plurality of clients and a set of PC specific processors (including the PC communication processor and the PC controller) is provided for each of a plurality of clients that handle different types of data, the client communication processor can be provided for each client if the clients handle different types of data.

When the data storing PC manager receives an activation notification from any of the data storing PCs that is received by one of the PC communication processors, information indicating that the data storing PC becomes available is stored in the HDD in association with corresponding identification information, the activated client can immediately use data in the data storing PC whose use is permitted, regardless of whether the data storing PC is extended or changed.

When the client communication processor receives a data acquisition request from one of the clients, the client communication processor inquires the data storing PC manager about a data storing PC holding data the client can use, and passes a data acquisition request to the PC controller for ensuring communication with the data storing PC that is acknowledged by the data storing PC manager, and the PC controller having received the data acquisition request converts the data acquisition request to a format compatible with the corresponding data storing PC, and passes the converted data acquisition request to the PC communication processor. Accordingly, the PC communication processor sends the data acquisition request to the corresponding data storing PC. This can ensure the acquisition of data from the data storing PC, and send the data to the client that has sent the data acquisition request.

When each PC controller receives a data acquisition result (data) in response to the data acquisition request from the corresponding PC communication processor, the PC controller converts the data acquisition result to a format each client can use, and passes the converted data acquisition result to the client communication processor. This allows the client that has sent the data acquisition request to surely use data acquired from the corresponding data storing PC.

When the client communication processor receives a data change request from one of the clients, the client communication processor inquires the data storing PC manager about a data storing PC holding data which the client can use, and passes a data change request to the PC controller for ensuring communication with the data storing PC that is acknowledged by the data storing PC manager, and the PC controller having received the data change request converts the data change request to a format compatible with the corresponding data storing PC, and passes the converted data change request to the PC communication processor. Accordingly, the PC communication processor sends the data change request to the corresponding data storing PC. This can ensure the change of data in the data storing PC.

When the client communication processor receives a data change request from any client, the client communication processor inquires the data storing PC manager about a data storing PC holding data the client can use and a client that can use the data stored in the data storing PC, inquires the client acknowledged by the data storing PC manager about whether data should be changed, and, upon reception of a notification indicating permission of a data change from the client, passes a data change request to the PC controller for ensuring communication with the data storing PC that is acknowledged by the data storing PC manager, and the PC controller having received the data change request converts the data change request to a format compatible with the corresponding data storing PC, and passes the converted data change request to the PC communication processor. Accordingly, the PC communication processor sends the data change request to the corresponding data storing PC. This can ensure the change of data in the data storing PC upon acquisition of data change permission from each client.

When each PC controller receives a data change result in response to the data change request from the corresponding PC communication processor, the PC controller converts the data change result to a format each client can use, and passes the converted data change result to the client communication processor. This allows the client communication processor to send the data change result to the client that has sent the data change request and display the contents of the data change result. Accordingly, the user who uses the client can know the contents of the data change result.

When the client communication processor receives a data change result from one of the PC controllers, the client communication processor inquires the data storing PC manager about a client that can use data stored in the data storage unit PC that has sent the data change result, and sends a data change occurrence notification notifying occurrence of a data change to the client acknowledged by the data storing PC manager to display the contents of the notification. Accordingly, each user who uses all the clients that could use data before change can know that the data change has taken place.

When each PC controller receives a data change occurrence notification from the corresponding PC communication processor, the PC controller can convert the data change occurrence notification to a format each client can use, pass the converted data change occurrence notification to the client communication processor, inquire the data storing PC manager about a client that can use data stored in the data storing PC that has sent the data change occurrence notification, send the data change occurrence notification to the client acknowledged by the data storing PC manager, and display the contents of the data change occurrence notification, whereby each user who uses all the clients that could use data before change can know that the data change has taken place.

When each PC controller receives a data change occurrence notification from the corresponding PC communication processor, the PC controller can convert the data change occurrence notification to a format each client can use, pass the converted data change occurrence notification to the client communication processor, inquire the data storing PC manager about a client that can use data stored in the data storing PC that has sent the data change occurrence notification, inquire the client acknowledged by the data storing PC manager about whether data should be changed, and, upon reception of a notification of data change permission from the client, send the data change occurrence notification to display the contents thereof, whereby each user who uses all the clients that could use data before change can know the occurrence of a data change. Furthermore, since a change in data in the data storing PC that has sent the data change occurrence notification is completed upon reception of data change permission from each client, each client can use data after change after making the permission.

Furthermore, when the client communication processor receives a notification to inhibit a data change in response to the inquiry about the client acknowledged by the data storing PC manager, the client communication processor passes a data change failure notification including identification information for identifying the client that has sent the notification to the PC controller that has passed the data change occurrence notification, and the PC controller having received the data change occurrence notification passes a data change occurrence notification to the client communication processor again after a predetermined time elapses. This can ensure the completion of the change in data in the data storing PC.

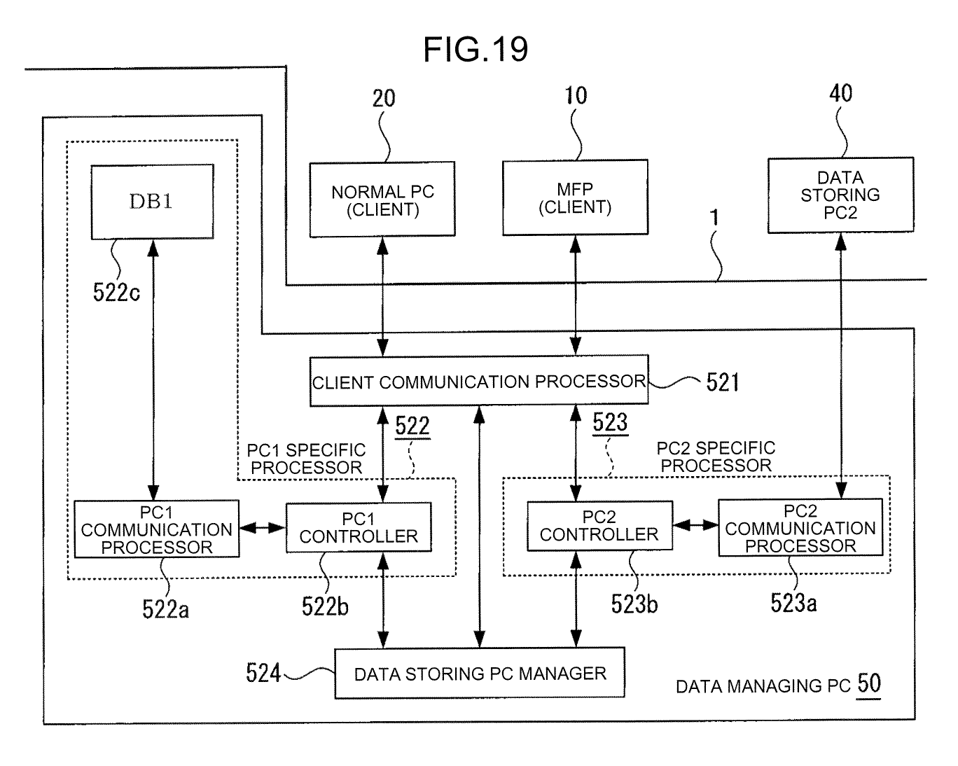

A DB (data) usable by each client is provided in an external data storing PC in the data processing system according to the present embodiment. However, as shown in FIG. 19, the data storing PC 30 can be omitted and a DB corresponding to the internal DB thereof can be provided as a DB 522c (DB1) in the PC1 specific processor 522 of the data managing PC 50. This configuration allows an access target to be changed to the DB 522c in some cases and to the internal DB of the data storing PC 40 in some cases, according to the situation. It is to be noted that the DB 522c performs a process similar to the process of the data storing PC 30. Likewise, the data storing PC 40 may not be used, and a DB corresponding to the internal DB thereof can be provided in the PC2 specific processor 523.

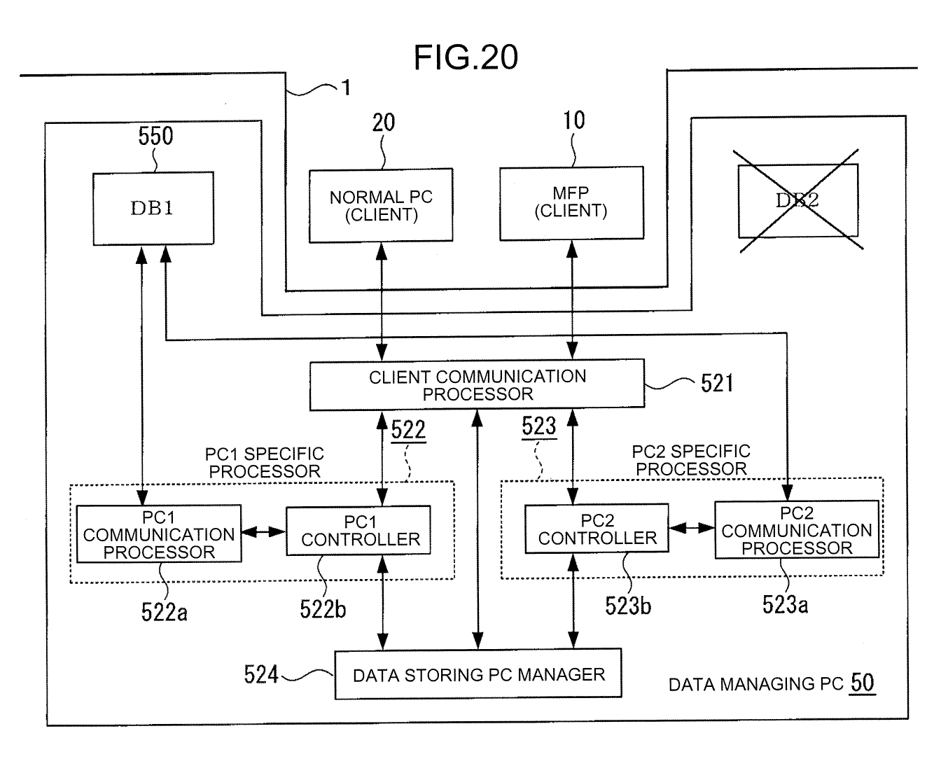

When DBs corresponding to the internal DBs of the data storing PCs 30, 40 are provided in the data managing PC 50, a common DB 550, which is a combination of the both of the DBs, can be provided. In this case, only the data acquisition scheme and the data processing scheme are changed, and same original data is used, as shown in FIG. 20, so that this modification is effective when single data is acquired by a plurality of different algorithms. Separate DBs can be also provided. The feature of the modified configurations, regardless of which configuration is employed, lies in that only part (a specific processor) of the software in the data managing PC 50 to be a server is changed, and clients that use the software do not recognize how the program on the server is constructed (namely, as to what method of connection to the data storing PC is used).

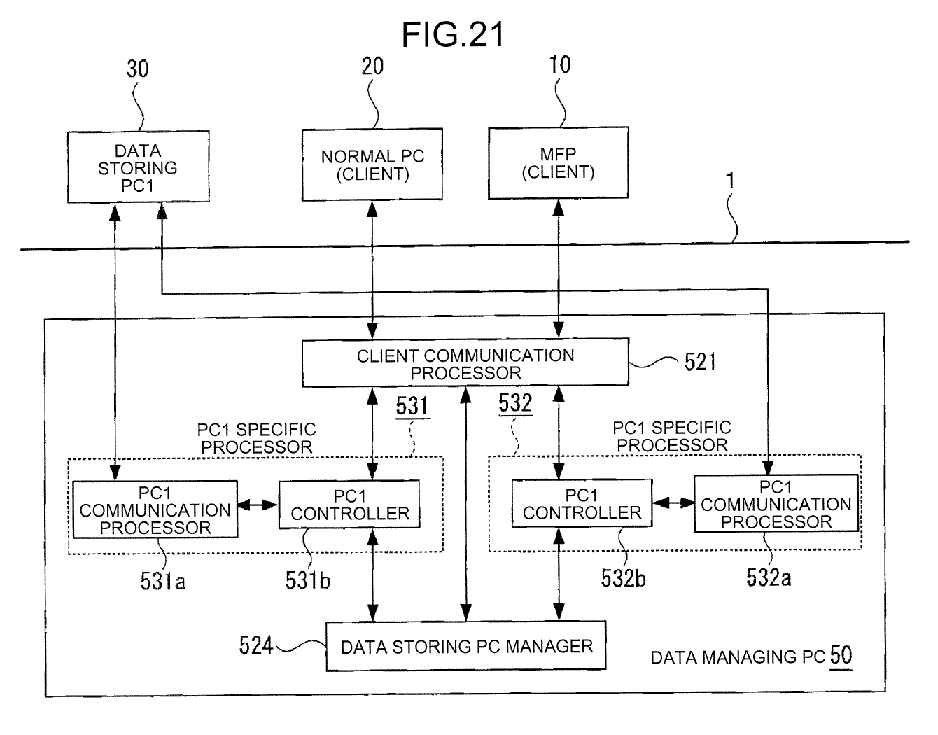

Besides the configuration having separate specific processors (specific processing software) for data storage units or the data storing PCs 30, 40, two types of PC1 specific processors 531, 532 that perform different control processes can be provided for the same data storing PC 30, as shown in FIG. 21.

The configuration allows processes for permitting use of data in the same data storing PC 30 to be performed according to the use environment of a client, e.g., one PC1 specific processor 531 to perform the following process (1) and the other PC1 specific processor 532 to perform the following process (2). The configuration brings about an effect of reducing correction of software when different processes are demanded.
(1) Executing a security-enhanced process such as “individual authentication”.
(2) Executing a process with lax security. A faster execution speed can be achieved instead.

Although the present embodiment explained above is adapted to the data processing system including a data managing PC and MFP, clients of normal PCs, and data storing PCs, the present invention is not limited to the present embodiment. The invention can be also adapted to a data processing system including a data managing PC, other clients and data storing PCs.

The program of the invention allows the data managing PC (a computer) to realize functions of a client communication processor (the first communication processing unit), a PC communication processor (the second communication processing unit) and a PC controller (a controller), which constitute a PC specific processor, and a data storing PC manager (an information manager). These effects mentioned above can be achieved by having such a program executed by a computer.

Such a program can be stored in advance in a memory unit, such as a ROM or an HDD, provided in a computer, or can be provided in the form of a compact disk (CD)-ROM or a flexible disk as a recording medium, or a non-volatile recording medium (a memory), such as SRAM, EEPROM, or a memory card where the program is recorded. Since the program recorded in the memory is installed on a computer and is executed by the CPU, or is read from the memory and is executed by the CPU, the procedures can be executed.

Alternatively, the program can be downloaded from an external device that is connected to a network and has a recording medium having the program recorded therein, and executed, or can be downloaded from an external device having the program stored in the memory unit thereof and executed.

According to an embodiment of the present invention, a connection processor (connection processing software) in a data managing apparatus (a computer) includes a first communication processing unit that communicates with a data processing device that processes data via a communication circuit, a second communication processing unit that communicates with a data storage unit (a DB device) that holds data via the communication circuit, an information manager that stores and manages identification information for identifying the data storage unit and identification information for identifying the data processing device that is permitted to use the data held in the data storage unit, in association with each other, and a controller that, based on a management status of the information manager, converts data from the data storage unit received by the second communication processing unit in a format usable by the data processing device, and converts data from the data processing device received by the first communication processing unit in a format compatible with the data storage unit. Accordingly, the following advantage can be achieved.

When a process of connecting to a data storage unit extended on a network (a communication circuit) is performed, or when a process of connecting to a changed DB device on a network is performed, it is sufficient to extend or change only the second communication processing unit and the controller that are units (software) for performing the connecting processes. This can allow a plurality of data processing devices to share data (DB) held in a data storage unit extended on a network or a changed data storage unit on a network without involving a significant cost increase, thereby achieving a low-cost data processing system.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data managing apparatus comprising:
a first communication processing unit that communicates with a data processing device that processes data;
a second communication processing unit that communicates with a data storing device that stores data;
an information managing unit that stores and manages identification information for identifying the data storing device and identification information for identifying the data processing device that is permitted to use the data stored in the data storing device, in a corresponding manner; and
a control unit that, based on a management status of the information managing unit, converts a format of data from the data storing device received by the second communication processing unit into a format that can be used by the data processing device, and converts a format of data from the data processing device received by the first communication processing unit into a format that can be used by the data storing device.

2. The data managing apparatus according to claim 1, wherein
the first communication processing unit is communicable with a plurality of data processing devices, and
a set of the second communication processing unit and the control unit is provided for each of a plurality of data storing devices having different data formats.

3. The data managing apparatus according to claim 2, wherein
upon receiving an activation notification from one of the data storing devices, the information managing unit stores information indicating that the data storing device is available, in association with corresponding identification information.

4. The data managing apparatus according to claim 2, wherein
the first communication processing unit includes a first passing unit that, upon receiving a data acquisition request from one of the data processing devices, inquires the information managing unit of a data storing device that stores data that can be used by the data processing device, and passes the data acquisition request to a control unit for enabling a communication with the data storing device that is responded to the inquiry by the information managing unit, and
each of the control units includes a second passing unit that, upon receiving the data acquisition request from the first communication processing unit, converts a format of the data acquisition request into a format that can be used by a corresponding data storing device, and passes the data acquisition request with the format converted to a corresponding second communication processing unit.

5. The data managing apparatus according to claim 4, wherein
each of the control units includes a third passing unit that, upon receiving a data acquisition result in response to the data acquisition request from a corresponding second communication processing unit, converts a format of the data acquisition result into a format that can be used by each of the data processing devices, and passes the data acquisition result with the format converted to the first communication processing unit.

6. The data managing apparatus according to claim 2, wherein
the first communication processing unit includes a first passing unit that, upon receiving a data change request from one of the data processing devices, inquires the information managing unit of a data storing device that stores data that can be used by the data processing device, and passes the data change request to a control unit for enabling a communication with the data storing device that is responded to the inquiry by the information managing unit, and
each of the control units includes a second passing unit that, upon receiving the data change request from the first communication processing unit, converts a format of the data change request into a format that can be used by a corresponding data storing device, and passes the data change request with the format converted to a corresponding second communication processing unit.

7. The data managing apparatus according to claim 2, wherein
the first communication processing unit includes a first passing unit that, upon receiving a data change request from one of the data processing devices, inquires the information managing unit of a data storing device that stores data that can be used by the data processing device and a data processing device that can use the data stored in the data storing device, inquires whether the data can be changed with respect to the data processing device that is responded to the inquiry by the information managing unit, and upon receiving a notification of permitting a data change from the data processing device, passes the data change request to a control unit for enabling a communication with the data storing device that is responded to the inquiry by the information managing unit, and
each of the control units includes a second passing unit that, upon receiving the data change request from the first communication processing unit, converts a format of the data change request into a format that can be used by a corresponding data storing device, and passes the data change request with the format converted to a corresponding second communication processing unit.

8. The data managing apparatus according to claim 6, wherein
each of the control units includes a third passing unit that, upon receiving a data change result in response to the data change request from a corresponding second communication processing unit, converts a format of the data change result into a format that can be used by each of the data processing devices, and passes the data change result with the format converted to the first communication processing unit.

9. The data managing apparatus according to claim 7, wherein
each of the control units includes a third passing unit that, upon receiving a data change result in response to the data change request from a corresponding second communication processing unit, converts a format of the data change result into a format that can be used by each of the data processing devices, and passes the data change result with the format converted to the first communication processing unit.

10. The data managing apparatus according to claim 9, wherein
the first communication processing unit includes a fourth passing unit that, upon receiving the data change result from one of the control units, inquires the information managing unit of a data processing device that can use data stored in a data storing device at a transmission source of the data change result, and passes a data change occurrence notification notifying an occurrence of a data change to the data processing device that is responded to the inquiry by the information managing unit.

11. The data managing apparatus according to claim 2, wherein
each of the control units includes a first passing unit that, upon receiving a data change occurrence notification notifying an occurrence of a data change from a corresponding second communication processing unit, converts a format of the data change occurrence notification into a format that can be used by each of the data processing devices, and passes the data change occurrence notification with the format converted to the first communication processing unit, and
the first communication processing unit includes a second passing unit that, upon receiving the data change occurrence notification from one of the control units, inquires the information managing unit of a data processing device that can use data stored in a data storing device at a transmission source of the data change occurrence notification, and passes the data change occurrence notification to the data processing device that is responded to the inquiry by the information managing unit.

12. The data managing apparatus according to claim 2, wherein
each of the control units includes a first passing unit that, upon receiving a data change occurrence notification notifying an occurrence of a data change from a corresponding second communication processing unit, converts a format of the data change occurrence notification into a format that can be used by each of the data processing devices, and passes the data change occurrence notification with the format converted to the first communication processing unit, and
the first communication processing unit includes a second passing unit that, upon receiving the data change occurrence notification from one of the control units, inquires the information managing unit of a data processing device that can use data stored in a data storing device at a transmission source of the data change occurrence notification, inquires whether the data can be changed with respect to the data processing device that is responded to the inquiry by the information managing unit, and upon receiving a notification of permitting a data change from the data processing device, passes the data change occurrence notification to the data processing device.

13. The data managing apparatus according to claim 12, wherein
the first communication processing unit includes a third passing unit that, upon receiving a notification of not permitting the data change from the data processing device, passes a data change failure notification including identification information for identifying the data processing device at a transmission source of the notification to the control unit from which the data change occurrence notification is received, and
each of the control units includes a fourth passing unit that, upon receiving the data change failure notification with respect to the data change occurrence notification from the first communication processing unit, passes the data change occurrence notification to the first communication processing unit again after a predetermined time.

14. A computer-readable recording medium that stores therein a computer program for managing data, wherein
the computer program causes a computer to execute:
first communication processing including
communicating with a plurality of data processing devices that processes data;
second communication processing including
communicating with a plurality of data storing devices that stores data;
information managing including
storing and managing identification information for identifying each of the data storing devices and identification information for identifying each of the data processing devices that is permitted to use the data stored in the data storing devices, in a corresponding manner; and
controlling, based on a management status of the information managing, including
converting a format of data from each of the data storing devices received at the second communication processing into a format that can be used by each of the data processing devices; and
converting a format of data from each of the data processing devices received at the first communication processing into a format that can be used by each of the data storing devices.

15. The computer-readable recording medium according to claim 14, wherein
upon receiving an activation notification from one of the data storing devices, the information managing includes storing information indicating that the data storing device is available, in association with corresponding identification information.

16. The computer-readable recording medium according to claim 14, wherein
the first communication processing includes first passing, upon receiving a data acquisition request from one of the data processing devices, including
inquiring the information managing of a data storing device that stores data that can be used by the data processing device; and
passing the data acquisition request to a controlling for enabling a communication with the data storing device that is responded to the inquiry at the information managing, and
each of the controlling includes second passing, upon receiving the data acquisition request from the first communication processing, including
converting a format of the data acquisition request into a format that can be used by a corresponding data storing device; and
passing the data acquisition request with the format converted to a corresponding second communication processing.

17. The computer-readable recording medium according to claim 14, wherein
the first communication processing includes first passing, upon receiving a data change request from one of the data processing devices, including
inquiring the information managing of a data storing device that stores data that can be used by the data processing device; and
passing the data change request to the controlling for enabling a communication with the data storing device that is responded to the inquiry at the information managing, and
each of the controlling includes second passing, upon receiving the data change request from the first communication processing, including
converting a format of the data change request into a format that can be used by a corresponding data storing device; and
passing the data change request with the format converted to a corresponding second communication processing.

18. The computer-readable recording medium according to claim 14, wherein
the first communication processing includes first passing, upon receiving a data change request from one of the data processing devices, including
inquiring the information managing of a data storing device that stores data that can be used by the data processing device and a data processing device that can use the data stored in the data storing device;
inquiring whether the data can be changed with respect to the data processing device that is responded to the inquiry at the information managing; and
passing, upon receiving a notification of permitting a data change from the data processing device, the data change request to a controlling for enabling a communication with the data storing device that is responded to the inquiry at the information managing, and
each of the controlling includes second passing, upon receiving the data change request from the first communication processing, including
converting a format of the data change request into a format that can be used by a corresponding data storing device; and
passing the data change request with the format converted to a corresponding second communication processing.

19. The computer-readable recording medium according to claim 14, wherein
each of the controlling includes first passing, upon receiving a data change occurrence notification notifying an occurrence of a data change from a corresponding second communication processing, including
converting a format of the data change occurrence notification into a format that can be used by each of the data processing devices; and
passing the data change occurrence notification with the format converted to the first communication processing, and
the first communication processing includes second passing, upon receiving the data change occurrence notification from one of the controlling, including
inquiring the information managing of a data processing device that can use data stored in a data storing device at a transmission source of the data change occurrence notification; and
passing the data change occurrence notification to the data processing device that is responded to the inquiry at the information managing.

20. The computer-readable recording medium according to claim 14, wherein
each of the controlling includes first passing, upon receiving a data change occurrence notification notifying an occurrence of a data change from a corresponding second communication processing, including
converting a format of the data change occurrence notification into a format that can be used by each of the data processing devices; and
passing the data change occurrence notification with the format converted to the first communication processing, and
the first communication processing includes second passing, upon receiving the data change occurrence notification from one of the controlling, including
inquiring the information managing of a data processing device that can use data stored in a data storing device at a transmission source of the data change occurrence notification;
inquiring whether the data can be changed with respect to the data processing device that is responded to the inquiry at the information managing; and
passing, upon receiving a notification of permitting a data change from the data processing device, the data change occurrence notification to the data processing device.
